(19) United States
(12) Patent Application Publication
(10) Pub. No.: US 2014/0018031 A1
(43) Pub. Date: Jan. 16, 2014

(54) WIRELESS COMMUNICATION SYSTEM, BASE STATION DEVICE, TERMINAL DEVICE, AND WIRELESS COMMUNICATION METHOD

(71) Applicant: FUJITSU LIMITED, Kawasaki-shi (JP)

(72) Inventor: Takayoshi ODE, Yokohama (JP)

(73) Assignee: FUJITSU LIMITED, Kawasaki-shi (JP)

(21) Appl. No.: 14/031,719

(22) Filed: Sep. 19, 2013

Related U.S. Application Data
(63) Continuation of application No. PCT/JP2011/058354, filed on Mar. 31, 2011.

(51) Int. Cl. H04W 4/22

(52) U.S. Cl. CPC H04W 4/22
USPC 455/404.1

(57) ABSTRACT

A wireless communication system includes one or more terminals; and a base station capable of communicating with the one or more terminals. The base station includes a specific communication control unit configured to control specific communication with a terminal belonging to a predetermined group among the one or more terminals, a non-specific communication control unit configured to control non-specific communication that is not limited to the predetermined group, and a warning message notifying unit configured to broadcast a warning message. The warning message notifying unit starts broadcasting the warning message after transmitting a notification indicating that the broadcasting of the warning message will start in the non-specific communication. The terminal includes a warning message receiving unit configured to attempt to receive the warning message broadcast from the base station, when the notification indicating that the broadcasting of the warning message will start in the non-specific communication is detected.

### CROSS-REFERENCE TO RELATED APPLICATION

This application is a U.S. continuation application filed under 35 USC 111(a) claiming benefit under 35 USC 120 and 365(c) of PCT application PCT/JP2011/058354 filed on Mar. 31, 2011, the entire contents of which are wholly incorporated herein by reference.

### FIELD

The embodiments discussed herein are related to a wireless communication system, a base station device, a terminal device, and a wireless communication method.

### BACKGROUND

Presently, in the 3GPP (3rd Generation Partnership Project), studies are made for specifications of a W-CDMA (Wideband-Code Division Multiple Access) system, a LTE (Long Term Evolution) system, and a LTE-Advanced system.

The W-CDMA is already used in services as HSDPA (W-CDMA Release (hereinafter, abbreviated as “Rel'”) 5) and HSPA (HSDPA+HSUPA W-CDMA Rel' 6). In 3GPP, studies are made for Rel' 10 as an improved version. Furthermore, the specification of LTE is formulated as LTE Rel' 8, which is scheduled to start being used in services in 2011. Furthermore, the specification of Rel' 9 is substantially formulated, and studies are made as LTE Rel' 10 for the specification of LTE-Advanced system, which is an expanded version of the present LTE system.

HeNB (Home e Node B) is an example being studied as LTE Rel' 9. The HeNB is also referred to as a Femto base station. Femto is referred to as Femto because the service range (or cell range) is narrower than that of a macro cell having a cell radius of several tens of km, a micro cell having a cell radius of several km, and a pico cell having a cell radius of approximately one km. Furthermore, in the conventional technology, studies are made for implementing HNB (Home Node B) also in W-CDMA (hereinafter, collectively referred to as HeNB).

HeNB has been conceived as a method for realizing wireless communications with good quality at locations where it is difficult for radio waves from outside to reach (blind zone), such as indoors and underground. Furthermore, implementation of relay is being studied for the same objective, by which wireless connections are set with a higher-level device (base station). Meanwhile, in HeNB, connections with a higher-level device are made in a wired manner with an optical line that is wired indoors. Thus, these two methods connect with a higher-level device by significantly different methods.

In short, HeNB is considered to be a so-called small size base station having low transmission power and limited radio frequencies that may be used. The difference between HeNB and a regular base station is that a regular base station is connected to a private network of the operator providing a mobile communication service, while HeNB is connected to a public network provided in households.

Thus, when performing communications via HeNB, the data is transmitted from a unique network of the operator to a gateway (GW) of a public network. Thus, the control of handover (hereinafter, also abbreviated as “HO”) to HeNB is different from HO control in a case where the communication is closed in a network of a regular operator.

Furthermore, as the installation locations of HeNB, homes and offices of companies are being considered. In this installation condition, the terminal connected to HeNB highly likely to be a specific user. For example, in an office, the user is highly likely to be limited to employees of that company, and in a home, the user is highly likely to be a family member living in the home. As described above, according to the installation condition of HeNB, security is enhanced by allowing connection for only a terminal of a specific user. That is to say, with HeNB, it is assumed that only a specific user (terminal) is allowed to be connected in terms of security.

Furthermore, in order to install HeNB, a connection is to be set to a wired line such as an optical line as described above. Therefore, if unspecified users are allowed to be connected free of charge, complimentary services are to be provided. This is difficult in terms of expenses in consideration of line connection fees as well as maintenance and operation fees.

As described above, studies are made for CSG (Closed Subscriber Group) as a mechanism of allowing connection to only specific subscribers (users). For connection setting, authentication is performed for allowing a connection between HeNB and a terminal. Specifically, according to whether a terminal has a specific CSG ID of the HeNB, it is determined whether connection is to be allowed or not allowed. Furthermore, for example, when the HeNB, which is the object of connection, has a CSG ID of ID 1, connection is possible if the terminal (UE) is holding ID 1, and connection is not allowed if the terminal (UE) is not holding ID 1.

Furthermore, in the conventional technology, there is a system of notifying warning messages to terminals when an emergency occurs such as earthquakes and tsunamis (see, for example, Patent Documents 1 and 2). Furthermore, as a system for notifying an emergency message to a terminal, there is a service called ETWS (Earthquake Tsunami Warning System). For example, ETWS corresponds to an area mail in FOMA (Freedom of Mobile multimedia Access; a mobile communication system provided by NTT DoCoMo, Inc.). ETWS is a service of immediately broadcasting emergency earthquake flash reports distributed by the Meteorological Agency. ETWS, PWS (Public Warning System), and CMAS (Commercial Mobile Alert System) are studied at 3GPP as services corresponding to area mail (see, for example, Non-patent Documents 1 through 6).

ETWS in an LTE system has an architecture in which CBC (Cell Broadcast Center) that is the information distribution server is connected to MME (Mobility Management Entity), and further connected to HeNB. Accordingly, the delivery load and the processing time of the emergency delivery server are reduced, so that the delivery time is reduced. Furthermore, in LTA, the distribution areas are defined as three types of areas, i.e., a distribution area of a Cell level, a distribution area of a TA (Tracking Area) level, and a distribution area of an EA (Emergency Area) level.
Patent document 1: Japanese National Publication of International Patent Application No. 2010-525752
Patent document 2: Japanese Laid-Open Patent Publication No. 2009-303227
Non-patent document 1: TS22.168V9.0.0, “Earthquake and Tsunami Warning System (ETWS) requirements; Stage 1 (Release 9)”
Non-patent document 2: TS22.268V9.2.1, “Public Warning System (PWS) requirements (Release 9)”
Non-patent document 3: TR23.828V8.0.0, “Earthquake and Tsunami Warning System (ETWS) Requirements and Solutions; Solution Placeholder”
Non-patent document 4: TR22.968V9.0.0, “Study for requirements for a Public Warning System (PWS) service (Release 9)”
Non-patent document 5: Itsuma Tanaka, “Improvement of Broadcasting of Emergency Information in Next-Generation Mobile Communication System”, NTT DoCoMo Technical Journal, Vo. 17, No. 3
Non-patent document 6: TS29.168V8.4.0, “Cell Broadcast Centre interfaces with the Evolved Packet Core; Stage 3 (Release 8)”

By receiving the above described ETWS message and PWS message (hereinafter, collectively referred to as “ETWS message”) as soon as possible, it becomes highly possible to avoid disasters that affect human lives. Thus, the ETWS message is to be notified as soon as possible to terminals from a base station. Furthermore, the message is to be reliably transmitted without failures by more than a predetermined level of transmission quality. That is to say, it is meaningless to send the message at a transmission quality which may lead to resending. Furthermore, in order to maintain the transmission quality and notify further ETWS messages, the messages are optimally notified from the base station for which the terminal has the highest reception power.

However, a base station (or HNB (Home Node B), HeNB (Home eNode B), hereinafter, collectively referred to as “HeNB”) that is nearest to the terminal forms a CSG (Closed Subscriber Group) that limits the terminals to be connected. Thus, if the terminal does not belong to CSG, the terminal is unable to connect to the base station. Accordingly, in worst cases, the terminal is unable to receive ETWS messages.

Furthermore, the above problems are not limited to Femto cells. The same problems arise in the case of relay (Relay Node, RN) forming CSG.

With respect to the above problems, in the conventional technology, there are no proposals made at 3GPP for broadcasting ETWS messages by CSG procedures or broadcasting ETWS messages by releasing CSG. Furthermore, studies are made for HeNB to provide both the services of CSG and Public (a communication format by which connections from all terminals are allowed, instead of only allowing connection of specific terminals as in CSG). However, there are no technologies where only CSG is used and CSG is temporarily released.

### SUMMARY

According to an aspect of the embodiments, a wireless communication system includes one or more terminals; and a base station capable of communicating with the one or more terminals, wherein the base station includes a specific communication control unit configured to control specific communication with a terminal belonging to a predetermined group among the one or more terminals, a non-specific communication control unit configured to control non-specific communication that is not limited to the predetermined group, and a warning message notifying unit configured to broadcast a warning message, wherein the warning message notifying unit starts broadcasting the warning message after transmitting a notification indicating that the broadcasting of the warning message will start in the non-specific communication, wherein the terminal includes a warning message receiving unit configured to attempt to receive the warning message broadcast from the base station, in a case where the notification indicating that the broadcasting of the warning message will start in the non-specific communication is detected.

The object and advantages of the invention will be realized and attained by means of the elements and combinations particularly pointed out in the appended claims. It is to be understood that both the foregoing general description and the following detailed description are exemplary and explanatory and are not restrictive of the invention as claimed.

### BRIEF DESCRIPTION OF THE DRAWINGS

FIG. 1 illustrates an architecture example of a wireless system;

FIG. 2 is a flowchart example illustrating a communication process of a base station according to a first embodiment;

FIG. 3 is a flowchart example illustrating a communication process (modification example 1) of a base station according to the first embodiment;

FIG. 4 is a flowchart example illustrating a communication process of a terminal according to the first embodiment;

FIG. 5 illustrates a block architecture example of a base station according to the first embodiment;

FIG. 6 illustrates a block architecture example (modification example 1) of a base station according to the first embodiment;

FIG. 7 illustrates a block architecture example (modification example 2) of a base station according to the first embodiment;

FIG. 8 illustrates a block architecture example of a terminal according to the first embodiment;

FIG. 9 illustrates a block architecture example of a terminal according to the first embodiment (modification example 1);

FIG. 10 illustrates a block architecture example of a terminal according to the first embodiment (modification example 2);

FIG. 11 illustrates a block architecture example of a terminal according to the first embodiment (modification example 3);

FIG. 12 illustrates a sequence example of handover according to the first embodiment;

FIG. 13 illustrates a sequence example for describing delivery of an ETWS message according to the first embodiment;

FIG. 14 illustrates a sequence example where the connection is directly set without handover to HeNB performing communication by CSG procedures;

FIG. 15 illustrates a sequence example of reconnection of CSG according to modification example 1;

FIG. 16 illustrates a sequence example of reconnection of CSG according to modification example 2;

FIG. 17 is a flowchart example illustrating a communication process of a base station according to a second embodiment;

FIG. 18 is a flowchart example illustrating a communication process of a base station according to the second embodiment (modification example 1);

FIG. 19 illustrates a block architecture example of a source base station according to the second embodiment;

FIG. 20 illustrates a block architecture example of a base station according to the second embodiment (modification example 1);

FIG. 21 illustrates a block architecture example of a terminal according to the second embodiment;

FIG. 22 illustrates a block architecture example of a terminal according to the second embodiment (modification example 1);

FIG. 23 illustrates a sequence example according to the second embodiment;

FIG. 24 is a flowchart illustrating a communication process example of a base station according to a third embodiment;

FIG. 25 is a flowchart example illustrating a communication process of a base station according to the third embodiment (modification example 1);

FIG. 26 illustrates a block architecture example of a base station according to the third embodiment;

FIG. 27 is a flowchart example illustrating a communication process of a base station according to a fourth embodiment;

FIG. 28 is a flowchart example illustrating a communication process of a base station according to the fourth embodiment (modification example 1);

FIG. 29 illustrates a block architecture example of a base station according to the fourth embodiment;

FIG. 30 is a flowchart example illustrating a communication process of a base station according to a fifth embodiment;

FIG. 31 illustrates a block architecture example of a base station according to the fifth embodiment; and

FIG. 32 illustrates a sequence example of a control procedure after transmitting an ETWS message according to the fifth embodiment.

### DESCRIPTION OF EMBODIMENTS

Preferred embodiments of the present invention will be explained with reference to accompanying drawings. In the following description, as an example of a warning message, ETWS is described. ETWS detects the first break (Primary wave, P wave) of an earthquake, and notifies a warning at once that an earthquake is imminent to terminals present in the detected area. In 3GPP, the first notification is to be delivered to the terminals within the minimum time (approximately four seconds after receiving emergency information). However, the quake of an S wave (Secondary wave) is typically larger than that of a P wave, and the quake of an S wave approaches later than a P wave. The time difference between a P wave and an S wave becomes larger as the distance from the earthquake center is larger, and becomes smaller as the distance from the earthquake center is smaller. That is to say, the quake becomes larger as the distance from the earthquake center is smaller, and therefore, many lives may be saved by delivering the warning as soon as possible after detecting the P wave. That is to say, there is demand to deliver the first notification as soon as possible.

Processes are performed so that when the first notification (primary notification) of ETWS is delivered to a terminal, a buzzer of the terminal is buzzed or a standard message set in advance is displayed on the screen of the terminal, to alert the user of the terminal. In the first notification, “earthquake”, “tsunami”, “earthquake+tsunami”, “test”, “other”, etc., are defined.

Furthermore, in ETWS, a second notification (secondary notification) is also set, which is for delivering supplementary information (the earthquake intensity, the earthquake center) that is not fully notified in the first notification. In the secondary notification, the same message as that provided in the conventional area mail, i.e., character information, is delivered from a network, to notify information such as the earthquake center and the earthquake intensity, to the terminals. Furthermore, in this message, a message identifier and a serial number are set, for indicating the type of disaster. Furthermore, ETWS is also applicable to global roaming, and when an operator from overseas is providing ETWS as a service, ETWS may be received overseas. Note that PWS is a format obtained by adding, to ETWS, the requirements of the countries such as the U.S.

### First Embodiment

### Wireless System Architecture

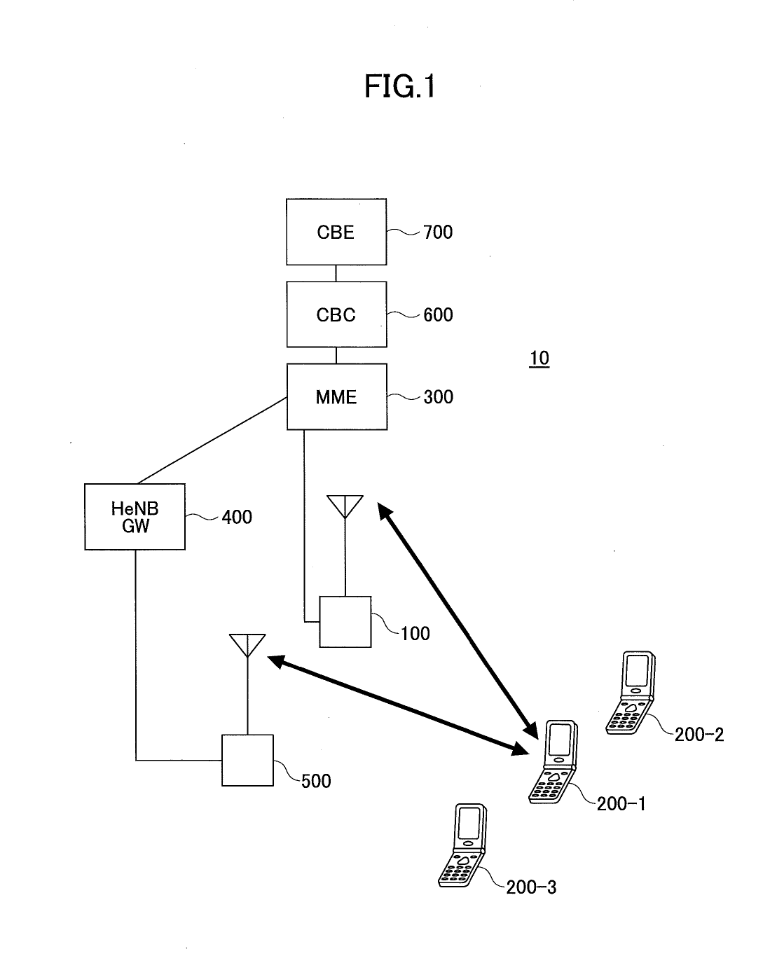

FIG. 1 illustrates an architecture example of a wireless system. A wireless system (wireless communication system) 10 illustrated in FIG. 1 includes a source base station (Source HeNB) 100, terminals (UE: User Equipment) 200-1 through 200-3, a MME (Mobility Management Entity, network) 300, a HeNB GW 400, a target base station (Target HeNB) 500, a CBC 600, and a CBE (Cell Broadcast Entity) 700. The number of elements and the arrangement are not limited to the above.

The source base station (Source HeNB) 100 and the target base station (Target HeNB) 500 transmit different data, and the terminals 200 receive this information (downlink direction). Furthermore, the terminals 200 may transmit different data to the source base station (Source HeNB) 100 and the target base station (Target HeNB) 500 (uplink direction). In 3GPP, the handover source is referred to as source, and the handover destination is referred to as target. Accordingly, in the first embodiment, two base stations are similarly identified.

The MME 300 is a higher-level device of the base stations (the base stations including the source base station 100 and the target base station 500), and acquires information at the time of a disaster (for example, the type of the disaster, the message main text, the delivery area, and a primary notification) from the CBC 600, and sends the information to a predetermined base station (source base station 100 and target base station 500).

The HeNB GW 400 sends the information obtained from the MME 300 to the target base station that is connected.

The CBC 600 creates a message to be delivered to the terminals 200 from information included in the delivery request for an emergency message (for example, an emergency information flash report) received from the CBE 700, and specifies the delivery area. The CBC 600 outputs the emergency message to the specified delivery area. The CBE 700 outputs a delivery request for an emergency message to the CBC 600.

In a system architecture described above, when an ETWS message is notified, the base station temporarily releases CSG, and makes a setting so that ETWS messages may be broadcast to all of the terminals 200-1 through 200-3. The fact that CSG has been released and connection has become possible may be broadcast before sending the ETWS message to all of the terminals 200-1 through 200-3.

### First Embodiment: Communication Process Example of Base Station

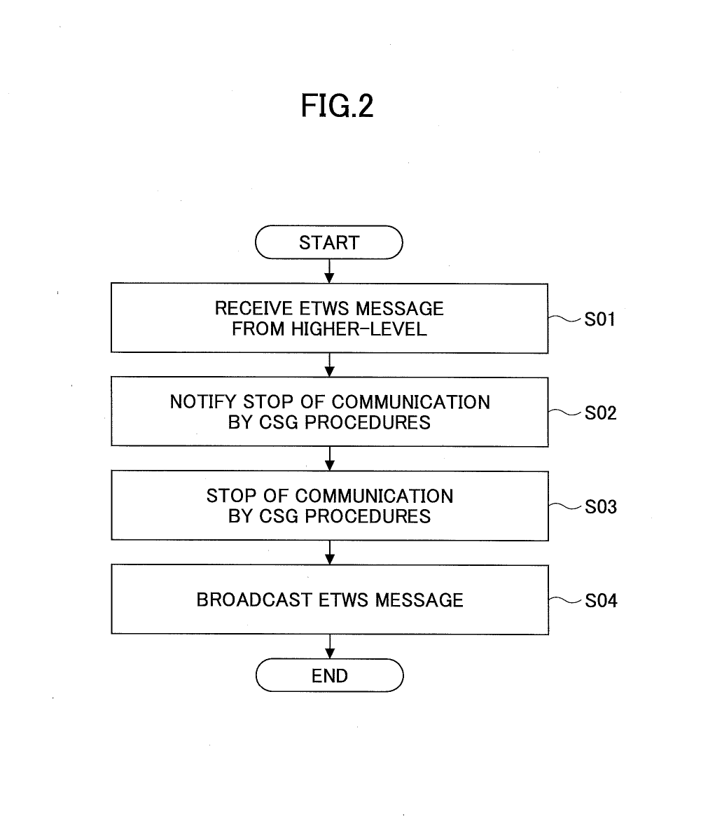

A detailed description is given of a communication process of a base station according to the first embodiment. Specifically, contents of a process of releasing communication by CSG procedures and performing ETWS transmission and a process of resuming communication by CSG procedures are described. FIG. 2 is a flowchart example illustrating a communication process of a base station according to the first embodiment. The process of FIG. 2 illustrates an example of a process of releasing communication by CSG procedures and performing ETWS transmission.

In the example of FIG. 2, when the source base station (Source HeNB) 100 is communicating with the terminal 200-1 by CSG procedures, the source base station (Source HeNB) 100 receives, from the MME 300, a request to send an ETWS message (Write-Replace Warning request) via a predetermined interface (step S01), to recognize the present area is a delivery area of the ETWS message. Next, in the example of FIG. 2, in a case of distributing an ETWS message, the source base station 100 prioritizes ETWS message transmission, and notifies that communication by CSG procedures is to be temporarily stopped to the terminal 200-1 with which communication is performed at that time point (step S02). Furthermore, the source base station 100 stops communication by CSG procedures (step S03).

The stop notification may be notified by using a paging channel (PCH) as a paging signal, or by using a downlink shared wireless channel (Physical Downlink Shared Channel: PDSCH) or a broadcast channel (Physical Broadcast Channel: PBCH), as system control information (System Information Block, SIB).

At the terminal 200-1 that has received the notification that communication by CSG procedures is to be stopped, the communication by CSG procedures is temporarily stopped. The paging signal of ETWS may have a meaning of a control signal for temporarily stopping communication by CSG procedures, or a control signal for temporarily stopping communication by CSG procedures may be notified as a different common control signal. Furthermore, in the example illustrated in FIG. 2, a request to shift to regular communication may be notified to the terminal 200-1.

Next, the setting of the target base station 500 is changed so as to be capable of communicating with all of the terminals, from the setting of only being capable of communicating with the terminal 200 belonging to CSG, and this is broadcast to the terminals 200 (for example, terminals 200-1 through 200-3) under the target base station 500 (step S04). The broadcasting may be performed with the use of a logical channel such as BCCH (Broadcast Control CHannel), and transmitted by a wireless broadcast channel (PBCH) or a downlink shared wireless channel (PDSCH). Furthermore, in another example, the broadcast may be transmitted by PCH (Paging CHannel) as a paging signal.

By the above process, the terminals 200 that have received a notification of regular communication may start communication with the target base station 500. This includes not only the terminal 200-1 that has been communicating by CSG procedures, but also the terminals 200-2 and 200-3 that are incapable of communicating by CSG procedures. Particularly, as to the terminals 200 which have not been connected to the HeNB before this time point, release of CSG is received and a channel with the HeNB is set. Next, the target base station 500 sends a paging signal of ETWS to the terminal 200 in the service area of the target base station 500. Alternatively, the target base station 500 sends an ETWS message. The paging signal and the ETWS message are repeatedly sent for a predetermined time period.

Accordingly, the terminals 200 receive a paging signal of ETWS, and perform a process of buzzing a buzzer. Furthermore, the terminals 200 receive the ETWS, and display this message on the screen of the terminal.

### First Embodiment: Communication Process Example of Base Station (Modification Example 1)

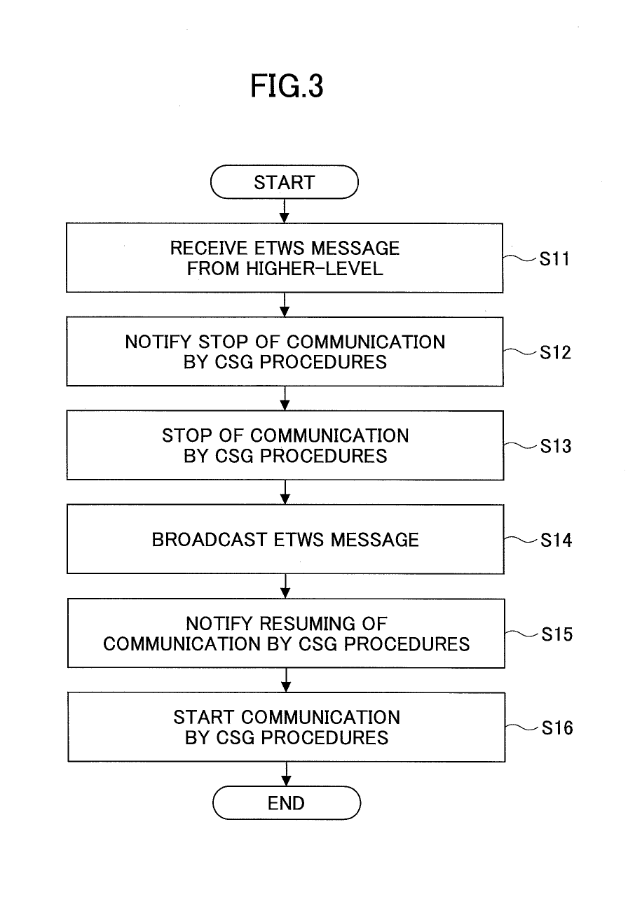

FIG. 3 is a flowchart example illustrating a communication process (modification example 1) of a base station according to the first embodiment. In the process of FIG. 3, after the process of releasing communication by CSG procedures and performing ETWS transmission illustrated in FIG. 2, a process of resuming communication by CSG procedures is added. Steps S11 through S14 in FIG. 3 are the same as steps S01 through S04 described above, and therefore specific descriptions are omitted.

In FIG. 3, by the process of step S14, when the transmission period of the paging signal and message of ETWS ends, the source base station 100 sends a notification that access control by CSG procedures is resumed for all terminals (step S15). The notification may be made with the use of a paging channel (PCH) as a paging signal, similar to the case of release. Furthermore, the notification may be made with the use of a downlink shared wireless channel (PDSCH) and a broadcast channel (PBCH) as system control information. Furthermore, in modification example 1, the end of the transmission period of the second notification is used as a standard for making the resume notification of step S15; however, the present invention is not so limited.

Subsequently, the source base station 100 starts communication with the terminals 200 included in CSG (step S16).

### First Embodiment: Communication Process Example of Terminal

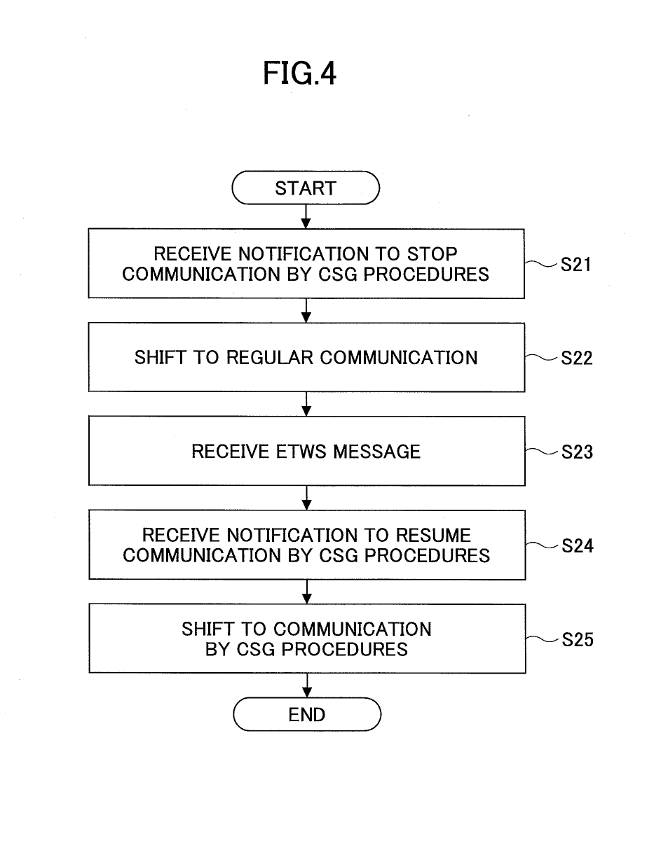

FIG. 4 is a flowchart example illustrating a communication process of a terminal according to the first embodiment. The example of FIG. 4 indicates a process corresponding to the process of FIG. 3 at the source base station 100 described above.

When a notification to stop communication by CSG procedures is received while communicating by CSG procedures (step S21), the terminal 200 implements control to shift to regular communication (step S22). Next, the terminal 200 receives the ETWS message sent form the source base station 100 (step S23). Furthermore, when a notification to resume communication by CSG procedures is received from the source base station 100 (step S24), the terminal 200 shifts to communication by CSG procedures (step S25), and returns to the state before the shift.

Accordingly, an ETWS message is quickly notified to the user of the terminal 200 from the target base station 500, without restrictions of CSG. Note that the transmission of the above ETWS message may be made from the source base station 100.

### First Embodiment: Block Architecture Example of Source Base Station 100

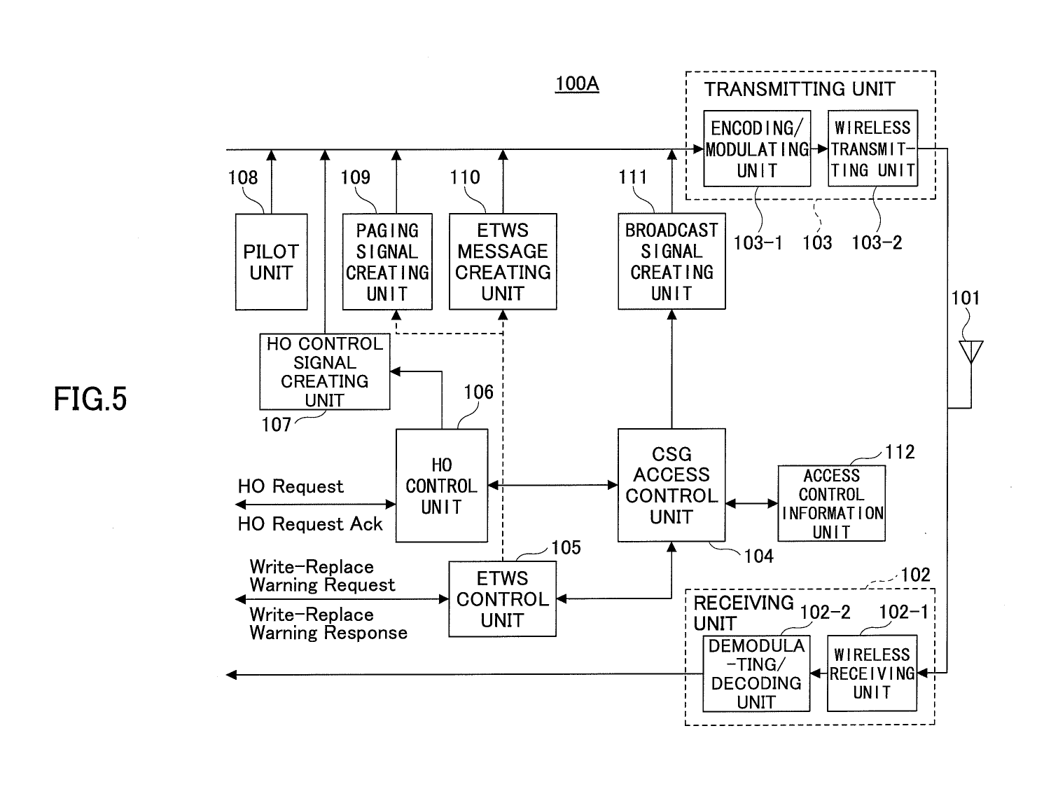

A description is given of a block architecture example of the source base station 100 according to the first embodiment, with reference to FIG. 5. The block architecture of the source base station 100 described below may be the same as the architecture of the target base station 500. Thus, in the following, descriptions of the architecture of the target base station 500 are omitted.

FIG. 5 illustrates a block architecture example of a base station according to the first embodiment. A source base station 100A illustrated in FIG. 5 includes an antenna unit 101, a receiving unit 102, a transmitting unit 103, a CSG access control unit 104, an ETWS control unit 105, a HO control unit 106, a HO control signal creating unit 107, a pilot unit 108, a paging signal creating unit 109, an ETWS message creating unit 110, and a broadcast signal creating unit 111. The antenna unit 101 performs transmission and reception of data with the terminal 200.

The antenna unit 101 outputs signals obtained from the terminal 200 to the receiving unit 102, and outputs signals obtained form the transmitting unit 103 to the terminal 200 or a higher-level device.

The receiving unit 102 includes a wireless receiving unit 102-1 and a demodulating/decoding unit 102-2. The receiving unit 102 extracts signals by the wireless receiving unit 102-1 from radio waves acquired by the antenna unit 101, and performs demodulating/decoding by the demodulating/decoding unit 102-2 on the extracted signals.

The transmitting unit 103 includes an encoding/modulating unit 103-1 and a wireless transmitting unit 103-2. The transmitting unit 103 acquires at least one data item from among a pilot signal obtained from the pilot unit 108, a HO control signal obtained from the HO control signal creating unit 107, a paging signal obtained from the paging signal creating unit 109, an ETWS message obtained from the ETWS message creating unit 110, and a broadcast signal obtained from the broadcast signal creating unit 111. Furthermore, the transmitting unit 103 performs encoding/modulating by the encoding/modulating unit 103-1 on the acquired data, and converts the data into a radio frequency that may be transmitted from the antenna unit 101 by the wireless transmitting unit 103-2.

The CSG access control unit 104 selects a corresponding terminal 200 and performs CSG access control based on access control information held in advance in an access control information unit 112. The access control information is, for example, CSG ID (first identification information). For example, when starting (or resuming) communication by CSG procedures, the CSG access control unit 104 notifies the terminal 200 of the CSG ID with the use of a paging channel, and establishes a wireless channel between the source base station 100A and the terminal 200 belonging to CSG.

The ETWS control unit 105 receives a Write-Replace Warning request from a higher-level device (for example, the MME 300). The ETWS control unit 105 requests the CSG access control unit 104 to send an ETWS message.

The ETWS control unit 105 outputs a control signal for creating an ETWS message to the paging signal creating unit 109 and the ETWS message creating unit 110. The ETWS control unit 105 sends a Write-Replace Warning response to a higher-level device that has made the request.

The HO control unit 106 performs HO control on a handover request (HO request) from a higher-level device. Specifically, the HO control unit 106 gives a creating instruction to the HO control signal creating unit 107. The HO control unit 106 gives handover acknowledgement (HO Request Ack) to the higher-level device that has made the HO request.

The pilot unit 108 generates a pilot signal used as a mark in wireless communication and outputs the pilot signal. Accordingly, the receiving side is capable of determining the transmission phase of the transmitted radio wave based on the phase of the received pilot signal.

The paging signal creating unit 109 creates a paging signal of ETWS according to a creating instruction obtained from the ETWS control unit 105.

The ETWS message creating unit 110 creates an ETWS message according to a creating instruction obtained from the ETWS control unit 105.

The broadcast signal creating unit 111 creates a broadcast signal corresponding to the CSG ID obtained by the CSG access control unit 104.

That is to say, in the example of FIG. 5, at the source base station 100, the ETWS control unit 105 that has received a Write-Replace Warning request from a higher-level device requests the CSG access control unit 104 to send an ETWS message. The CSG access control unit 104 that has received the request sends a notification to the ETWS control unit 105 to allow ETWS transmission. The ETWS control unit 105 that has received the acknowledgement notification requests the paging signal creating unit 109 to create a paging signal that is a first notification of ETWS.

The paging signal creating unit 109 that has received the request creates a paging signal that is the first notification of ETWS, encodes and modulates the paging signal at the encoding/modulating unit 103-1, converts the signal into a radio frequency at the wireless transmitting unit 103-2, and sends the signal to the terminal 200. The architecture of the source base station 100A illustrated in FIG. 5 is capable of performing a process corresponding to the flowchart of FIG. 2.

### First Embodiment: Block Architecture Example of Source Base Station 100 (Modification Example 1)

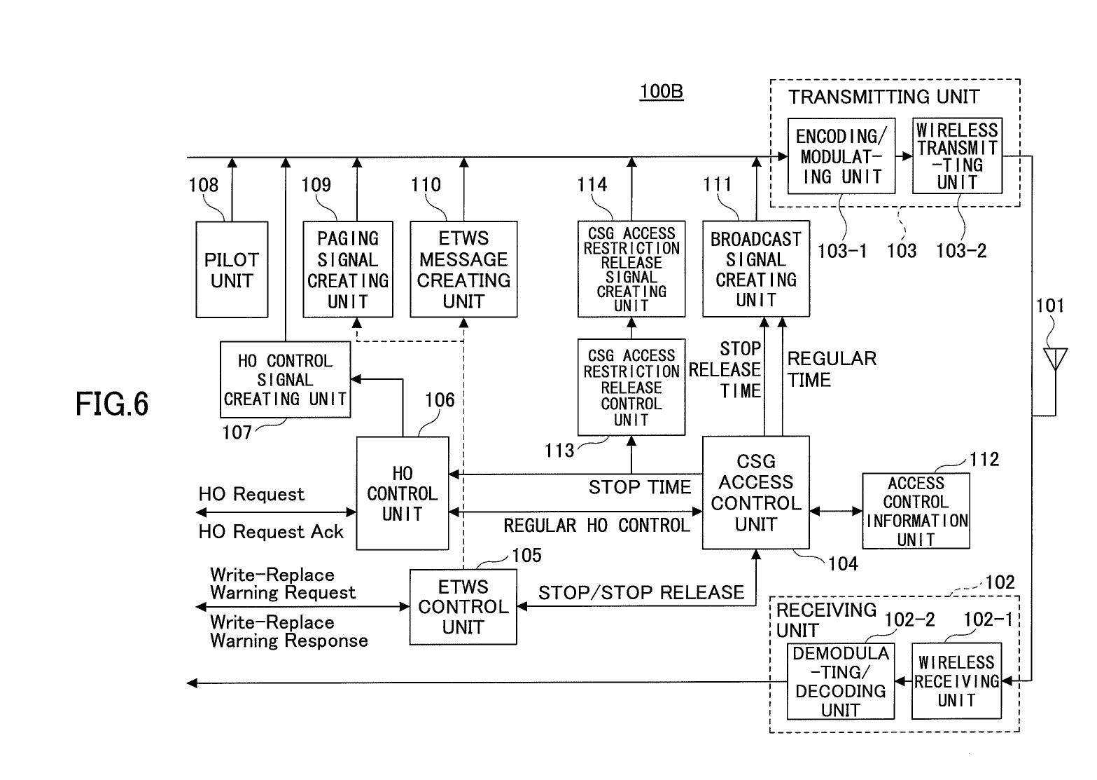

Next, a description is given of a block architecture example (modification example 1) of the source base station 100 according to the first embodiment, with reference to FIG. 6. FIG. 6 illustrates a block architecture example (modification example 1) of a base station according to the first embodiment. The blocks having the same functions as the blocks illustrated in FIG. 5 are denoted by the same reference numerals and specific descriptions are omitted.

A source base station 100B illustrated in FIG. 6 includes the antenna unit 101, the receiving unit 102, the transmitting unit 103, the CSG access control unit 104, the ETWS control unit 105, the HO control unit 106, the HO control signal creating unit 107, the pilot unit 108, the paging signal creating unit 109, the ETWS message creating unit 110, the broadcast signal creating unit 111, a CSG access restriction release control unit 113, and a CSG access restriction release signal creating unit 114. That is to say, in the example of FIG. 6, the CSG access restriction release control unit 113 and the CSG access restriction release signal creating unit 114 are further added to the block architecture of FIG. 5 described above.

In the architecture of FIG. 6, an element including the CSG access restriction release signal creating unit 114, the encoding/modulating unit 103-1, and the wireless transmitting unit 103-2 corresponds to a specific communication stop notifying unit.

Furthermore, in the architecture of FIG. 6, an element including the paging signal creating unit 109, the ETWS message creating unit 110, the encoding/modulating unit 103-1, and the wireless transmitting unit 103-2 corresponds to a warning message notifying unit. The ETWS control unit 105 includes a warning message receiving unit.

In the base station architecture diagram of FIG. 6, the ETWS control unit 105, which has received a Write-Replace Warning request from a higher-level device, requests the CSG access control unit 104 to release CSG access control in order to stop communication by CSG procedures.

Furthermore, the CSG access control unit 104 requests the CSG access restriction release control unit 113 to release CSG access control. The CSG access restriction release control unit 113 requests the CSG access restriction release signal creating unit 114 to create a release signal. Furthermore, the CSG access control unit 104 requests the HO control unit 106 to cause the terminal 200 to handover from CSG communication to regular communication.

Furthermore, after the transmission of a paging signal that is the first notification of ETWS and the transmission of an ETWS message that is the second notification have been completed, the ETWS control unit 105 notifies an ETWS-replace warning request to a higher-level device (for example, MME), and requests the CSG access control unit 104 to resume access restriction on a terminal by CSG procedures. In the present modification example, after the transmission of a paging signal that is the first notification of ETWS and the transmission of an ETWS message that is the second notification have been completed, the reception of a resume notification from a higher-level device (for example, MME 300, HeNB GW 400) may be waited for. That is to say, after transmission of the second notification of ETWS is completed, it is determined whether reception of a resume notification from a higher-level device has been detected, and the resuming of access restriction by CSG procedures may be waited for until it is determined that reception of a resume notification has been detected in the determination process.

After receiving the request, the CSG access control unit 104 requests the broadcast signal creating unit 111 to broadcast the resuming of communication by CSG procedures and to broadcast a CSG ID for performing communication by CSG procedures. The broadcast signal creating unit 111 that has received the request creates a CSG resume control signal for notifying the resuming of the communication by CSG procedures, encodes and modulates the signal at the encoding/modulating unit 103-1, converts the signal into a radio frequency at the wireless transmitting unit 103-2, and then sends the signal to the terminal 200.

Similarly, the broadcast signal creating unit 111 creates a signal for broadcasting a CSG ID for performing communication by CSG procedures, and transmits the signal to the terminal in the same manner as the resume notification. In this example, the CSG resume notification and the notification of a CSG ID are described as different notifications; however, the CSG ID may be notified together with the CSG resume notification. The above process corresponds to the flow of FIG. 3 described above.

Contrary to the release of a specific communication described above, modification example 1 described above may include a function of sending a notification indicating the start of a specific communication after broadcasting the warning message. In this case, for example, a CSG access restriction start control unit and a CSG access restriction start signal creating unit are included, corresponding to the CSG access restriction release control unit 113 and the CSG access restriction release signal creating unit 114, respectively. In this case, an element including the CSG access restriction start signal creating unit, the encoding/modulating unit 103-1, and the wireless transmitting unit 103-2 corresponds to a specific communication start notifying unit. As to the operations, a start notifying process is performed conversely to the above specific communication release notification, and therefore detailed descriptions are omitted.

### First Embodiment: Block Architecture Example of Source Base Station 100 (Modification Example 2)

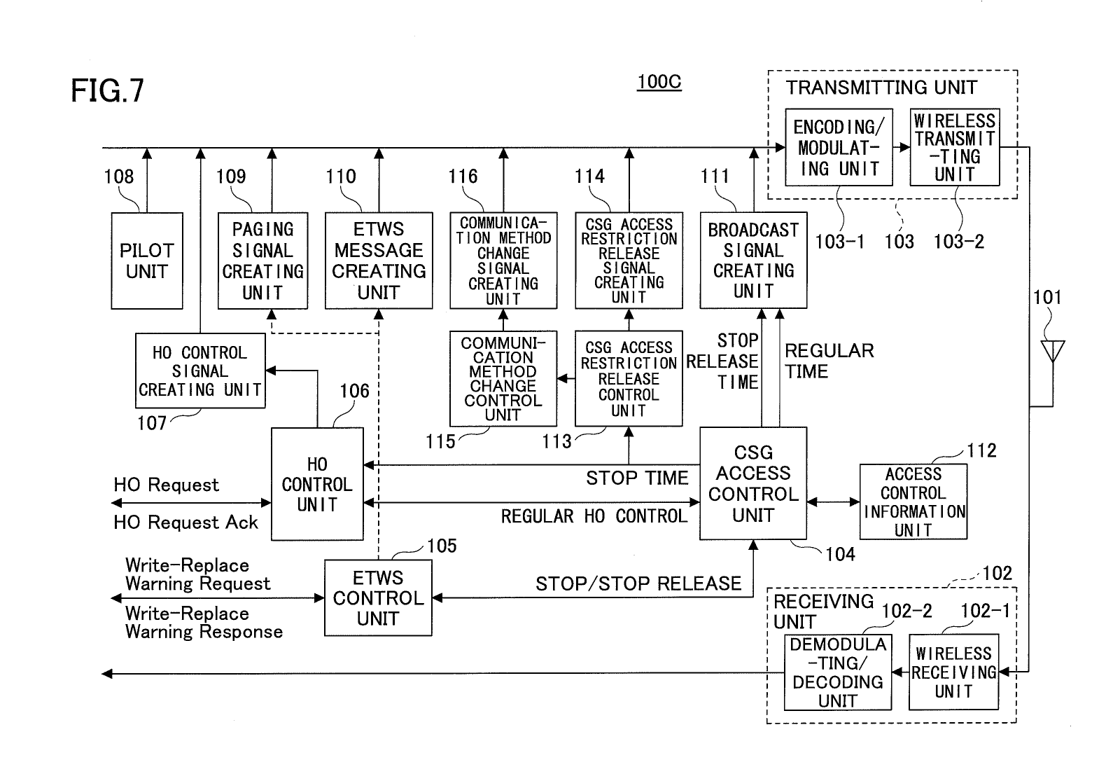

Next, a description is given of a block architecture example (modification example 2) of the source base station 100 according to the first embodiment, with reference to FIG. 7. FIG. 7 illustrates a block architecture example (modification example 2) of a base station according to the first embodiment. The blocks having the same functions as the blocks described above are denoted by the same reference numerals and specific descriptions are omitted.

A source base station 100C illustrated in FIG. 7 includes the antenna unit 101, the receiving unit 102, the transmitting unit 103, the CSG access control unit 104, the ETWS control unit 105, the HO control unit 106, the HO control signal creating unit 107, the pilot unit 108, the paging signal creating unit 109, the ETWS message creating unit 110, the broadcast signal creating unit 111, the CSG access restriction release control unit 113, the CSG access restriction release signal creating unit 114, a communication method change control unit 115, and a communication method change signal creating unit 116. That is to say, in the example of FIG. 7, the communication method change control unit 115 and the communication method change signal creating unit 116 are further added to the block architecture of FIG. 6 described above. In modification example 2, an element including the communication method change signal creating unit 116 illustrated in FIG. 7, the encoding/modulating unit 103-1, and the wireless transmitting unit 103-2 corresponds to a communication method change notifying unit.

In the base station architecture diagram of FIG. 7, the ETWS control unit 105, which has received a Write-Replace Warning request from a higher-level device, requests the CSG access control unit 104 to release CSG access control in order to stop communication by CSG procedures.

Furthermore, the CSG access control unit 104 requests the CSG access restriction release control unit 113 to release CSG access control. The CSG access restriction release control unit 113 requests the communication method change control unit 115 to notify the change to regular communication, and requests the CSG access restriction release signal creating unit 114 to create a release signal. Furthermore, the CSG access control unit 104 requests the HO control unit 106 to cause the terminal 200 to handover from CSG communication to regular communication.

The communication method change control unit 115 requests the communication method change signal creating unit 116 to create a signal for changing the communication method. The changing of the communication method means, for example, to change from communication by CSG procedures to regular communication in which the terminals capable of communicating are not restricted. Furthermore, the CSG access restriction release signal creating unit 114 creates a release signal. The created release signal is encoded and modulated at the encoding/modulating unit 103-1, converted into a radio frequency at the wireless transmitting unit 103-2, and sent as a radio wave from the antenna unit 101.

Furthermore, the communication method change signal creating unit 116 creates a change notification signal. The created change notification signal is encoded and modulated at the encoding/modulating unit 103-1, converted into a radio frequency at the wireless transmitting unit 103-2, and sent as a radio wave from the antenna unit 101.

As to the CSG access restriction release signal and the communication change signal described above, one of these may also serve as the other and vice versa.

Furthermore, the ETWS control unit 105, which has detected the completion of the transmission of a paging signal that is the first notification of ETWS and the transmission of an ETWS message that is the second notification, requests the CSG access control unit 104 to resume access restriction of the terminals 200 by CSG procedures. After receiving the request, the CSG access control unit 104 requests the broadcast signal creating unit 111 to broadcast the resuming of communication by CSG procedures and to broadcast a CSG ID for performing communication by CSG procedures. The broadcast signal creating unit 111 that has received the request creates a CSG resume control signal for notifying the resuming of the communication by CSG procedures. The created CSG resume control signal is encoded and modulated at the encoding/modulating unit 103-1, converted into a radio frequency at the wireless transmitting unit 103-2, and then output as a radio wave from the antenna unit 101.

The broadcast signal creating unit 111 creates a broadcast signal for broadcasting a CSG ID for performing communication by CSG procedures. The created broadcast signal is encoded and modulated at the encoding/modulating unit 103-1, converted into a radio frequency at the wireless transmitting unit 103-2, and then output as a radio wave from the antenna unit 101.

In this example, the CSG resume notification and the notification of a CSG ID are described as different notifications; however, both of these notifications may be made together at once.

In the above modification example, although not illustrated in FIG. 7, when resuming CSG communication, the resuming of CSG communication may be notified from the CSG access control unit 104 to the communication method change control unit 115, and the communication method change control unit 115 may request the communication method change signal creating unit 116 to create a communication method change signal for notifying the resuming of CSG communication, and send the communication method change signal to the terminal in the same manner as above.

### First Embodiment: Block Architecture Example of Terminal 200

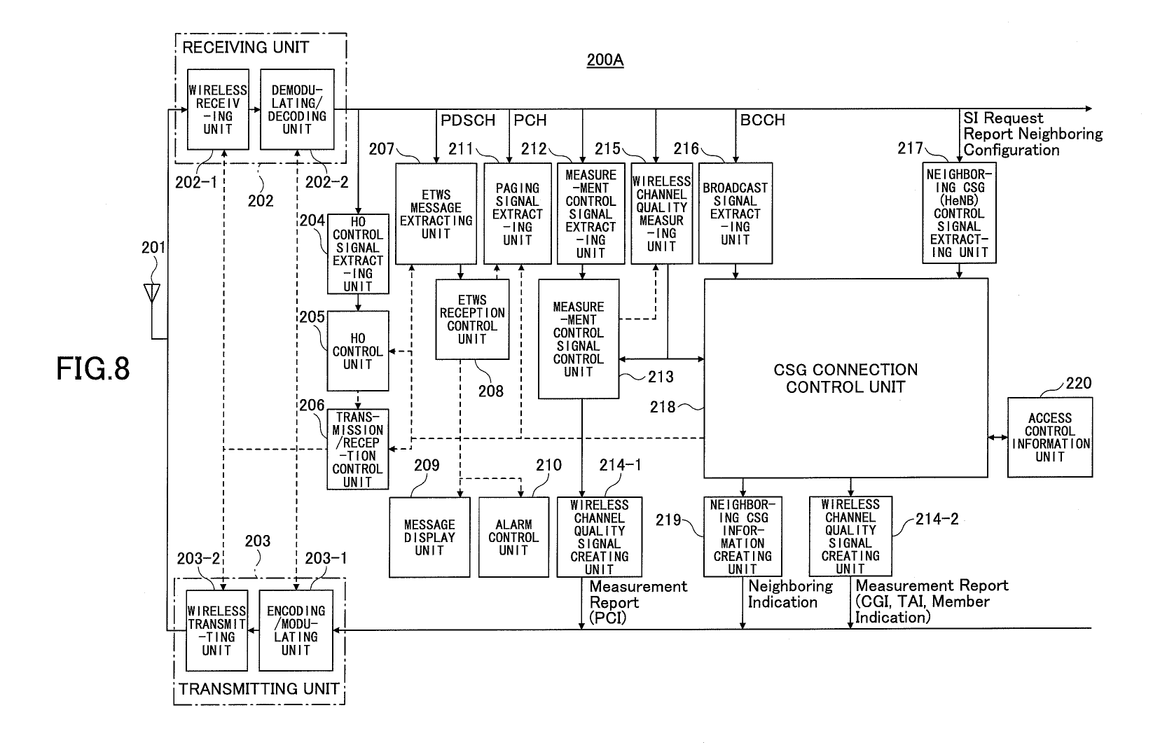

Next, a description is given of a block architecture example of the terminal 200 according to the first embodiment, with reference to FIG. 8. FIG. 8 illustrates a block architecture example of the terminal according to the first embodiment.

A terminal 200A illustrated in FIG. 8 includes an antenna unit 201, a receiving unit 202, a transmitting unit 203, a HO control signal extracting unit 204, a HO control unit 205, a transmission/reception control unit 206, an ETWS message extracting unit 207, an ETWS reception control unit 208, a message display unit 209, an alarm control unit 210, a paging signal extracting unit 211, a measurement control signal extracting unit 212, a measurement control signal control unit 213, wireless channel quality signal creating units 214-1, 214-2, a wireless channel quality measuring unit 215, a broadcast signal extracting unit 216, a neighboring CSG (HeNB) control signal extracting unit 217, a CSG connection control unit 218, and a neighboring CSG information creating unit 219.

The antenna unit 201 performs transmission/reception of data with the source base station 100 (target base station 500) with radio waves. That is to say, the antenna unit 201 outputs a signal obtained form the source base station 100 (target base station 500) to the receiving unit 202, and outputs a signal obtained from the transmitting unit 203 to the source base station 100 (target base station 500).

The receiving unit 202 includes a wireless receiving unit 202-1 and a demodulating/decoding unit 202-2. The receiving unit 202 extracts, with the wireless receiving unit 202-1, a signal from the wireless radio wave acquired by the antenna unit 201, and performs demodulating and decoding on the extracted signal with the demodulating/decoding unit 202-2.

The transmitting unit 203 includes an encoding/modulating unit 203-1 and a wireless transmitting unit 203-2. The transmitting unit 203 acquires at least one data item among a Measurement Report (for example, PCI or CGI, TAI, Member Indication (information indicating whether member of CSG), etc.) obtained from the wireless channel quality signal creating units 214-1, 214-2, and a Neighboring Indication obtained from the neighboring CSG information creating unit 219. Furthermore, the transmitting unit 203 performs encoding and modulating on the acquired data with the encoding/modulating unit 203-1, and converts, with the wireless transmitting unit 203-2, the data into a radio frequency that may be transmitted from the antenna unit 201.

The HO control signal extracting unit 204 extracts, from the signal that has been demodulated/decoded obtained from the demodulating/decoding unit 202-2, a HO control signal for performing control relevant to handover.

The HO control unit 205 performs handover control such as switching the base station (HeNB) for connection, based on the signal extracted from the HO control signal extracting unit 204, and based on the control information from the CSG connection control unit 218.

The transmission/reception control unit 206 controls the transmission/reception of contents controlled by the HO control unit 205 and performs control on the reception by the receiving unit 202 and the transmission by the transmitting unit 203, based on the control information from the CSG connection control unit 218.

The ETWS message extracting unit 207 extracts an ETWS message (PDSCH) based on control information from the CSG connection control unit 218. Furthermore, the ETWS message extracting unit 207 outputs the extracted ETWS message to the ETWS reception control unit 208. The ETWS reception control unit 208 causes the message display unit 209 to display the ETWS message extracted by the ETWS message extracting unit 207, and notifies the user who is using the terminal 200 by light, sound, or vibration with the alarm control unit 210. Furthermore, the ETWS reception control unit 208 outputs a control signal for extracting a paging signal to the paging signal extracting unit 211.

The message display unit 209 displays an ETWS message from the ETWS reception control unit 208 on a screen such as a display. The message display unit 209 is, for example, a liquid crystal screen.

The alarm control unit 210 notifies an alarm for reporting that an ETWS message has been received based on an ETWS reception signal from the ETWS reception control unit 208. The alarm may be, for example, light, sound, or vibration.

The paging signal extracting unit 211 extracts a paging signal (PCH) from a signal extracted by the receiving unit 202, based on a control signal from the CSG connection control unit 218.

The measurement control signal extracting unit 212 extracts a measurement control signal from the signal received by the receiving unit 202. Furthermore, when the measurement control signal is extracted, the measurement control signal extracting unit 212 outputs the measurement control signal to the measurement control signal control unit 213.

The measurement control signal control unit 213 causes the wireless channel quality measuring unit 215 to perform quality measurement of a wireless channel, based on the measurement control signal obtained from the measurement control signal extracting unit 212. When a quality measurement result is acquired from the wireless channel quality measuring unit 215, the measurement control signal control unit 213 causes the wireless channel quality signal creating unit 214 to output the quality measurement result.

The wireless channel quality signal creating unit 214-1 creates a quality signal (for example, including a Measurement Report (PCI)) corresponding to the quality result from the measurement control signal control unit 213.

Furthermore, the wireless channel quality signal creating unit 214-2 creates a quality signal (for example, including a Measurement Report (CGI, TAI, Member Indication)) corresponding to the quality result from the CSG connection control unit 218. In the example of FIG. 8, the wireless channel quality signal creating units 214-1, 214-2 constitute separate blocks; however, the present invention is not so limited, the wireless channel quality signal creating units 214-1, 214-2 may constitute a single block.

The wireless channel quality measuring unit 215 measures the quality of the wireless channel based on the received signal. The wireless channel quality measuring unit 215 measures the quality based on the packet loss, the delay, the fluctuation, and the frequency band; however, the present invention is not so limited. The wireless channel quality measuring unit 215 outputs the measured quality result to the measurement control signal control unit 213 and the CSG connection control unit 218.

The broadcast signal extracting unit 216 extracts a broadcast signal (BCCH) from the signal received from the receiving unit 202. Furthermore, the broadcast signal extracting unit 216 outputs the extracted broadcast signal to the CSG connection control unit 218.

The neighboring CSG (HeNB) control signal extracting unit 217 extracts a neighboring CSG (HeNB) control signal (SI request, report neighboring architecture) from the signal received by the receiving unit 202. Furthermore, the neighboring CSG (HeNB) control signal extracting unit 217 outputs the extracted neighboring CSG (HeNB) control signal to the CSG connection control unit 218.

The CSG connection control unit 218 controls CSG connection at the terminal 200. Specifically, the CSG connection control unit 218 performs CSG connection control based on the broadcast signal (for example, CSG ID) from the broadcast signal extracting unit 216 and access control information (for example, CSG ID) held in advance in an access control information unit 220.

Furthermore, the CSG connection control unit 218 causes the wireless channel quality signal creating unit 214-2 to create a wireless channel quality signal (for example, including a Measurement Report (CGI, TAI, Member Indication)), based on the quality report obtained from the wireless channel quality measuring unit 215.

Furthermore, the CSG connection control unit 218 outputs a control signal for creating neighboring CSG information to the neighboring CSG information creating unit 219, based on a neighboring CSG (HeNB) control signal obtained from the neighboring CSG (HeNB) control signal extracting unit 217.

When performing the CSG control, the CSG connection control unit 218 controls, for example, the HO control unit 205, the transmission/reception control unit 206, the ETWS message extracting unit 207, and the paging signal extracting unit 211.

The neighboring CSG information creating unit 219 creates neighboring CSG information (Neighboring Indication) based on a control signal from the CSG connection control unit 218.

With the architecture example of FIG. 8, immediately after extracting an ETWS, CSG connection control is performed and an ETWS message is notified.

That is to say, in the terminal architecture diagram of FIG. 8, the terminal 200A changes the signal received from the antenna unit 201 into a base band signal at the wireless receiving unit 202-1, and demodulates and decodes the signal at the demodulating/decoding unit 202-2. From the signal output from the receiving unit 202, the paging signal extracting unit 211 extracts a paging signal that is a first notification of ETWS, and outputs the paging signal to the ETWS reception control unit 208. The ETWS reception control unit 208 that has received the first notification requests the message display unit 209 to display the ETWS message, and requests the alarm control unit 210 to ring the alarm. The message display unit 209 displays the first notification of ETWS, and the alarm control unit 210 warns the user by ringing the alarm (for example, by ringing the alarm and vibrating with a vibrator).

The example of the terminal 200A corresponds to the example of the source base station 100A described above. The architecture of the terminal 200A is applicable to the terminals 200-1 through 200-3 of FIG. 1.

In the above example, when making the connection state of the terminal 200 return to the original state, for example, the terminal 200 may be controlled to return to the original state when a predetermined time set elapses after displaying the ETWS message with the message display unit 209; however, the present invention is not so limited.

### First Embodiment: Block Architecture Example of Terminal 200 (Modification Example 1)

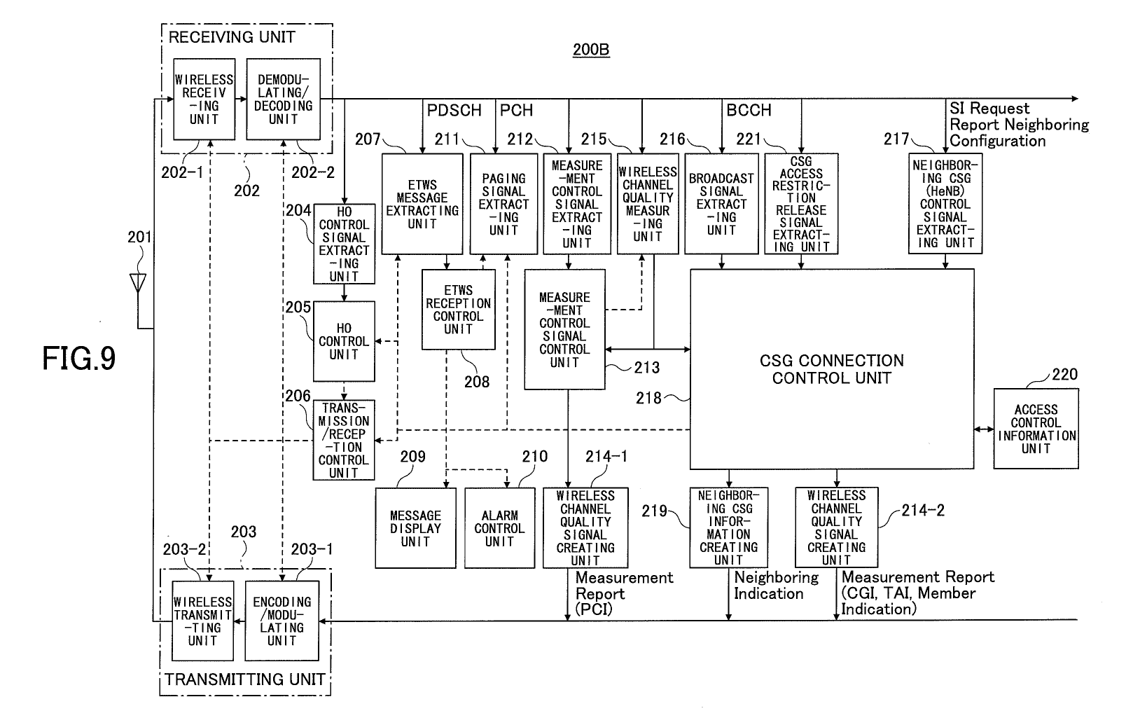

Next, a description is given of a block architecture example of the terminal 200 according to the first embodiment (modification example 1), with reference to FIG. 9. FIG. 9 illustrates a block architecture example of the terminal according to the first embodiment (modification example 1). The blocks having the same functions as the blocks of the terminal 200A described above are denoted by the same reference numerals and specific descriptions are omitted.

A terminal 200B illustrated in FIG. 9 includes an antenna unit 201, a receiving unit 202, a transmitting unit 203, a HO control signal extracting unit 204, a HO control unit 205, a transmission/reception control unit 206, an ETWS message extracting unit 207, an ETWS reception control unit 208, a message display unit 209, an alarm control unit 210, a paging signal extracting unit 211, a measurement control signal extracting unit 212, a measurement control signal control unit 213, wireless channel quality signal creating units 214-1, 214-2, a wireless channel quality measuring unit 215, a broadcast signal extracting unit 216, a neighboring CSG (HeNB) control signal extracting unit 217, a CSG connection control unit 218, a neighboring CSG information creating unit 219, and a CSG access restriction release signal extracting unit 221.

That is to say, in the example of the terminal 200B of modification example 1, the CSG access restriction release signal extracting unit 221 is further added to the terminal 200A described above. In FIG. 9, an element including the paging signal extracting unit 211, the wireless receiving unit 202-1, and the demodulating/decoding unit 202-2 corresponds to a specific communication stop notification receiving unit. Furthermore, an element including the CSG connection control unit 218 of FIG. 9 corresponds to a communication control unit. The communication control unit includes a specific communication control unit for controlling specific communication with a terminal belonging to a predetermined group and a non-specific communication control unit for controlling non-specific communication which is communication that is not limited to a predetermined group.

Furthermore, an element including the ETWS message extracting unit 207, the paging signal extracting unit 211, the wireless receiving unit 202-1, and the demodulating/decoding unit 202-2 in FIG. 9 corresponds to a warning message receiving unit.

In the terminal architecture diagram of FIG. 9, a received signal is changed into a base band signal at the wireless receiving unit 202-1, which is demodulated and decoded at the demodulating/decoding unit 202-2, to create a signal. From the created signal, the CSG access restriction release signal extracting unit 221 extracts a CSG access restriction release signal, and sends a notification to the CSG connection control unit 218.

Upon receiving the notification from the CSG access restriction release signal extracting unit 221, the CSG connection control unit 218 requests the HO control unit 205 to handover to regular communication. The HO control unit 205 performs the handover, and shifts to regular communication. After shifting to regular communication, a paging signal and an ETWS signal are received. According to modification example 1, a signal is generated based on the CSG access restriction release signal.

### First Embodiment: Block Architecture Example of Terminal 200 (Modification Example 2)

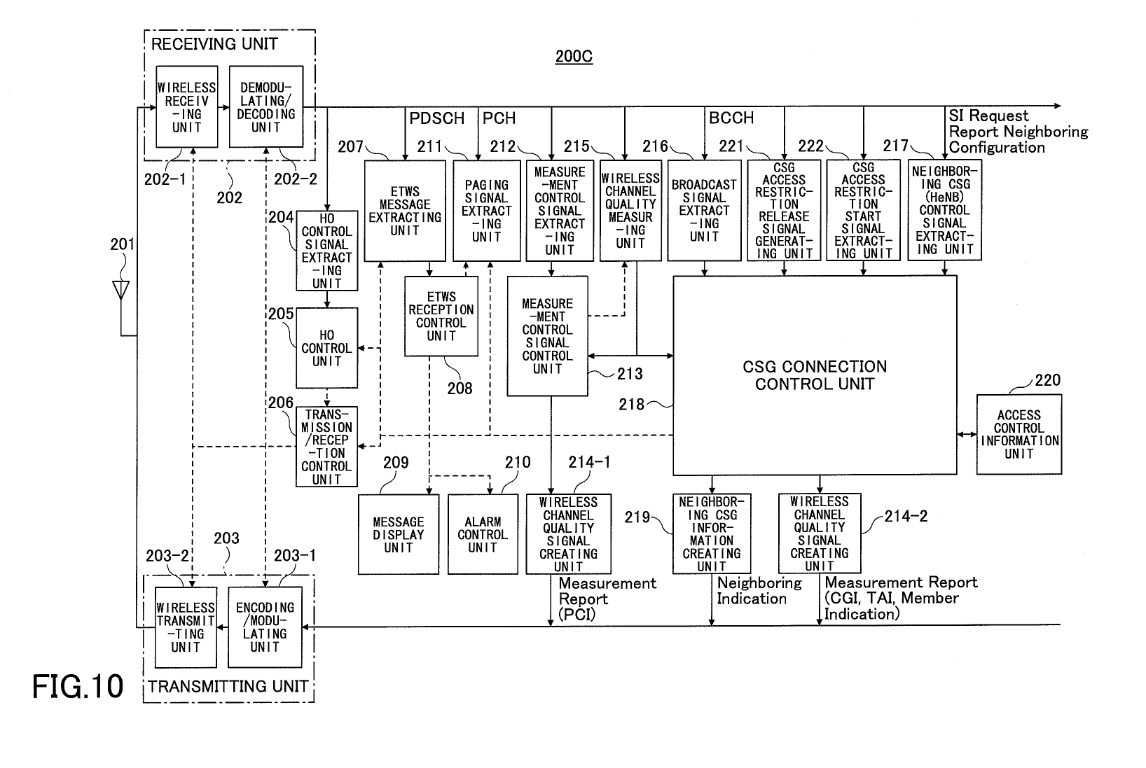

Next, a description is given of a block architecture example of the terminal 200 according to the first embodiment (modification example 2), with reference to FIG. 10. FIG. 10 illustrates a block architecture example of the terminal according to the first embodiment (modification example 2). The blocks having the same functions as the blocks of architecture described above are denoted by the same reference numerals and specific descriptions are omitted.

A terminal 200C illustrated in FIG. 10 includes an antenna unit 201, a receiving unit 202, a transmitting unit 203, a HO control signal extracting unit 204, a HO control unit 205, a transmission/reception control unit 206, an ETWS message extracting unit 207, an ETWS reception control unit 208, a message display unit 209, an alarm control unit 210, a paging signal extracting unit 211, a measurement control signal extracting unit 212, a measurement control signal control unit 213, wireless channel quality signal creating units 214-1, 214-2, a wireless channel quality measuring unit 215, a broadcast signal extracting unit 216, a neighboring CSG (HeNB) control signal extracting unit 217, a CSG connection control unit 218, a neighboring CSG information creating unit 219, a CSG access restriction release signal extracting unit 221, and a CSG access restriction start signal extracting unit 222.

That is to say, in the example of the terminal 200C of modification example 2, the CSG access restriction start signal extracting unit 222 is further added to the terminal 200B of modification example 1 described above.

In the terminal architecture diagram of FIG. 10, a signal received from the antenna unit 201 is changed to a base band signal at the wireless receiving unit 202-1, and demodulated/decoded at the demodulating/decoding unit 202-2. From the signal output from the receiving unit 202, the CSG access restriction release signal extracting unit 221 extracts a CSG access restriction release signal, and outputs the CSG access restriction release signal to the CSG connection control unit 218. Upon receiving the CSG access restriction release signal, the CSG connection control unit 218 requests the HO control unit 205 to handover to regular communication. The HO control unit 205 performs the handover, and shifts to regular communication. After shifting to regular communication, a paging signal and an ETWS signal are received.

Furthermore, in modification example 2, the CSG access restriction start signal extracting unit 222 extracts a CSG access restriction start signal from the signal output from the receiving unit 202. The CSG access restriction start signal is a signal generated by the specific communication start notifying unit for transmitting a notification indicating the start of specific communication at the base station after a warning message is broadcast.

Furthermore, the CSG access restriction start signal extracting unit 222 outputs the extracted CSG access restriction start signal to the CSG connection control unit 218. Furthermore, in modification example 2, the broadcast signal extracting unit 216 extracts a broadcast signal (BCCH) such as CSG ID from the signal output from the receiving unit 202, and sends a notification to the CSG connection control unit 218.

After receiving the CSG access restriction start notification from the CSG access restriction start signal extracting unit 222, the CSG connection control unit 218 determines whether CSG connection is possible based on the broadcast signal (CSG ID, etc.) from the broadcast signal extracting unit 216 and the access control information stored in advance in the access control information unit 220. Subsequently, CSG access control is performed with the source base station 100, and the CSG connection is set up.

### First Embodiment: Block Architecture Example of Terminal 200 (Modification Example 3)

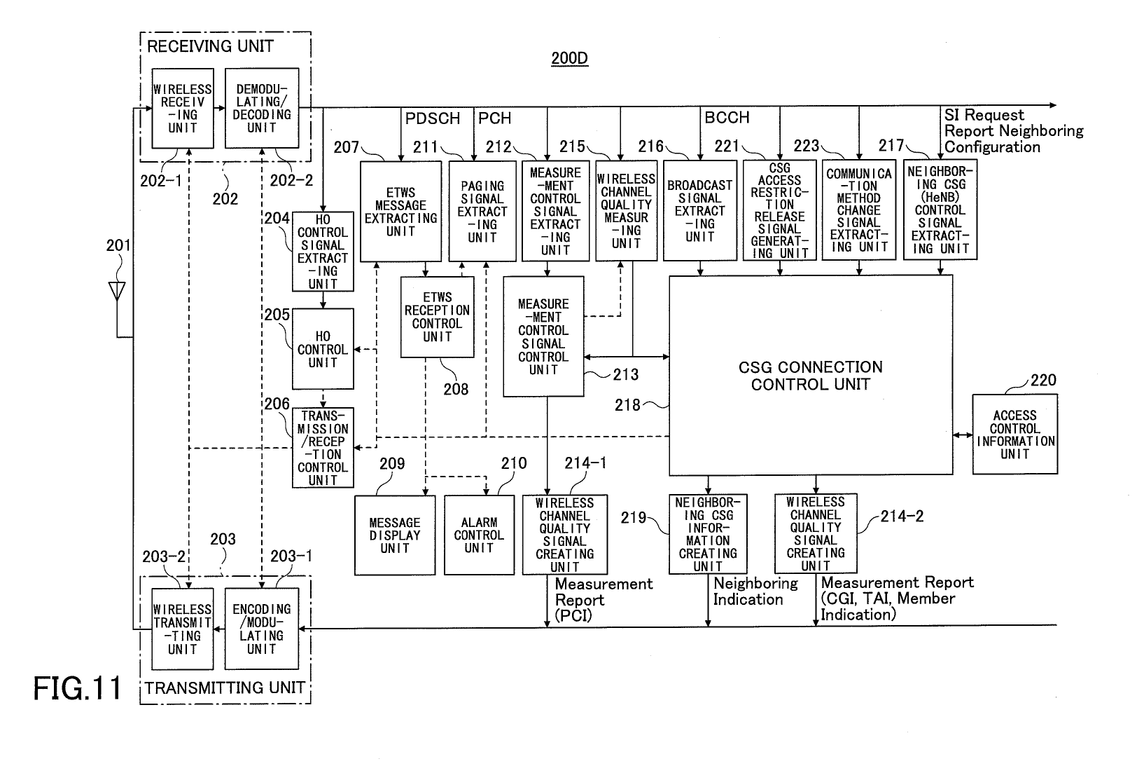

Next, a description is given of a block architecture example of the terminal 200 according to the first embodiment (modification example 3), with reference to FIG. 11. FIG. 11 illustrates a block architecture example of the terminal according to the first embodiment (modification example 3). The blocks having the same functions as the blocks of the architecture described above are denoted by the same reference numerals and specific descriptions are omitted.

A terminal 200D illustrated in FIG. 11 includes an antenna unit 201, a receiving unit 202, a transmitting unit 203, a HO control signal extracting unit 204, a HO control unit 205, a transmission/reception control unit 206, an ETWS message extracting unit 207, an ETWS reception control unit 208, a message display unit 209, an alarm control unit 210, a paging signal extracting unit 211, a measurement control signal extracting unit 212, a measurement control signal control unit 213, wireless channel quality signal creating units 214-1, 214-2, a wireless channel quality measuring unit 215, a broadcast signal extracting unit 216, a neighboring CSG (HeNB) control signal extracting unit 217, a CSG connection control unit 218, a neighboring CSG information creating unit 219, a CSG access restriction release signal extracting unit 221, and a communication method change signal extracting unit 223.

That is to say, in the terminal 200D of modification example 3, the communication method change signal extracting unit 223 is added to the terminal 200C of modification example 2 described above instead of the CSG access restriction start signal extracting unit 222. In FIG. 11, an element including the communication method change signal extracting unit 223, the wireless receiving unit 202-1, and the demodulating/decoding unit 202-2 corresponds to a communication method change notification receiving unit.

In the terminal architecture diagram of FIG. 11, a signal received from the antenna unit 201 is changed to a base band signal at the wireless receiving unit 202-1, and demodulated/decoded at the demodulating/decoding unit 202-2. From the signal output from the receiving unit 202, the CSG access restriction release signal extracting unit 221 extracts a CSG access restriction release signal.

Furthermore, the CSG access restriction release signal extracting unit 221 outputs the extracted CSG access restriction release signal to the CSG connection control unit 218.

Furthermore, in modification example 3, the communication method change signal extracting unit 223 extracts a communication method change control signal from the signal output from the receiving unit 202. Furthermore, the communication method change signal extracting unit 223 outputs the extracted communication method change control signal to the CSG connection control unit 218.

The CSG connection control unit 218 controls the stopping of communication by CSG procedures based on the communication method change control signal obtained by the communication method change signal extracting unit 223, and notifies the HO control unit 205 to handover to regular communication.

The process of the shifting is performed in the same manner as the process of modification example 2 described above. Furthermore, in FIG. 11, the communication method change signal extracting unit 223 is provided instead of the CSG access restriction start signal extracting unit 222; however, the present invention is not so limited. For example, in addition to changing the communication method from CSG communication to regular communication, the change from regular communication to CSG communication may be notified, and the same function as the CSG access restriction start signal extracting unit 222 may be provided.

### Sequence of Handover According to First Embodiment

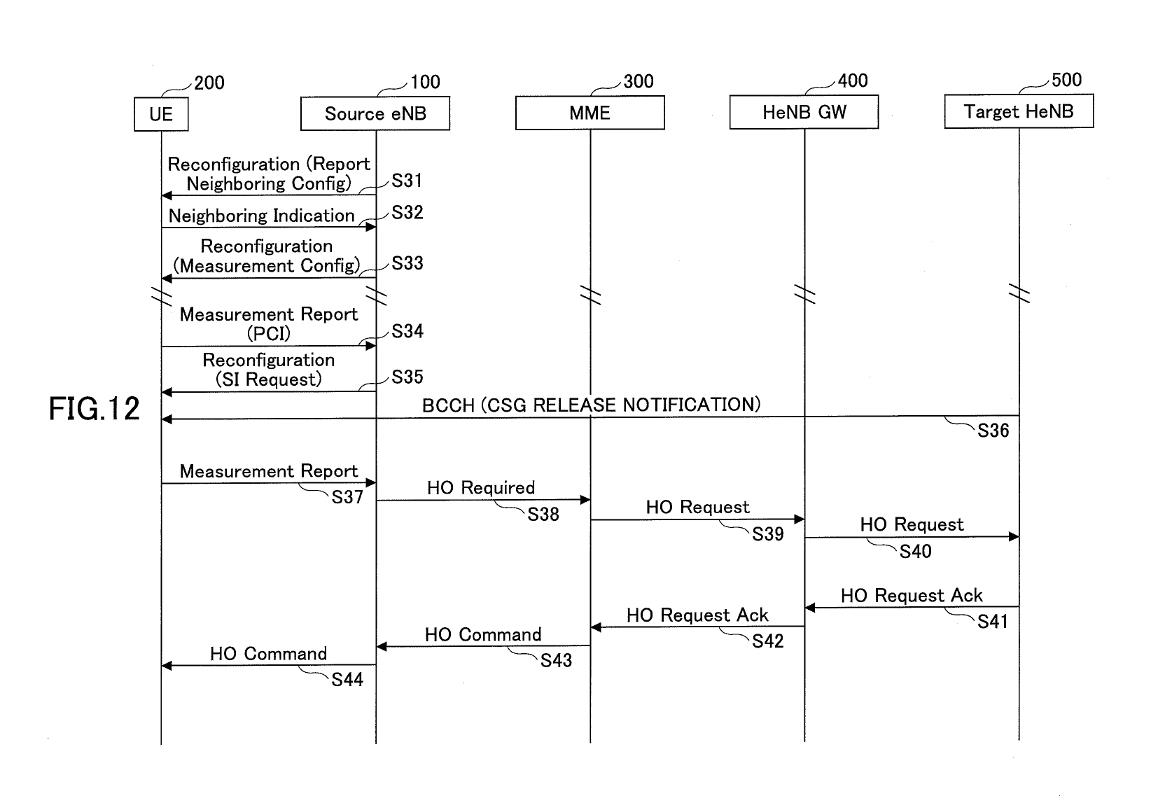

Next, a description is given, with reference to FIG. 12, of a case where in response to the release of CSG communication, the terminal 200 that has been connected to another base station hands over to the target base station 500, in the first embodiment. FIG. 12 illustrates a sequence example of handover according to the first embodiment. In the example of FIG. 12, a description is given of a wireless system including a terminal (UE) 200, two base stations, i.e., the source base station (Source HeNB) 100 and the target base station (Target HeNB) 500, and higher-level devices including the MME 300, and the HeNB GW 400.

First, the source base station 100 notifies the terminal 200 of information of an adjacent CSG cell (Report Neighboring Architecture) (step S31). The Neighboring Architecture is different from an adjacent cell list which is a list of base stations adjacent to a particular base station.

Next, the terminal (UE) 200 notifies the source base station (Source HeNB) 100 to which the terminal (UE) 200 is connected, that the terminal (UE) 200 is approaching the Femto cell having a CSG ID of a CSG list (for example, a white list) to which the terminal (UE) 200 may be connected (step S32).

When the terminal 200 does not have a measurement condition with respect to RAT (Radio Access Technology) and the frequency used by CSG procedures, the source base station 100 notifies control information (Measurement Architecture) such as a measurement condition from the base station to which the terminal 200 is connected (step S33).

The terminal 200 includes a physical cell ID (PCI: Physical Cell Identifier) in the result measured with the use of the notified control information, and notifies the result to the source base station 100 to which the terminal 200 is connected (step S34).

The source base station 100 makes a system information SI request to the terminal 200 based on the information obtained by the process of step S34 (step S35).

In this case, the target base station 500 broadcasts the release of CSG communication by BCCH of logical CH (logical channel), to the terminal 200 present in the HeNB cell (step S36). The wireless channel (physical channel) is broadcast with the use of PBCH.

The terminal 200, which has received the CSG release notification, reports the reception quality from HeNB (for example, the wireless channel quality such as the receiving electric field intensity) to the source base station 100 to which the terminals 200 are connected (step S37).

The source base station 100 that has received the report notifies, via the MME 300 that is a higher-level device, a handover request (HO request) to the HeNB GW 400 that is a gate way to public lines (steps S38 and S39). Furthermore, the HeNB GW 400 requests HO to the target base station 500 that is the HeNB of the handover destination (step S40).

The target base station 500 that has received the handover request determines the possibility of HO, and when the target base station (HeNB) 500 determines that HO is possible, the target base station (HeNB) 500 notifies the MME 300 of a handover acknowledgement (HO request Ack) via the HeNB GW 400 through a route opposite to the above (steps S41, S42). When a handover acknowledgement is received from the target base station 500, the MME 300 notifies the terminal 200 of a handover command via the source base station 100 (step S44). Subsequently, delivery of an ETWS message is performed.

### Example of Delivery of ETWS Message

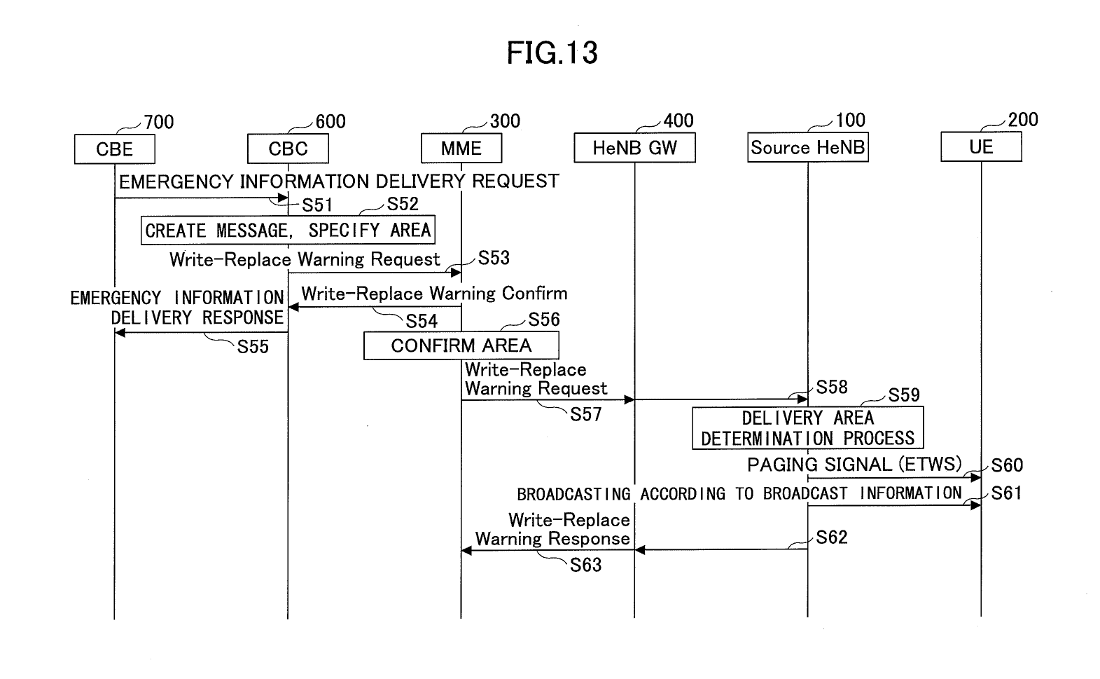

Next, a description is given of delivery of an ETWS message according to the first embodiment, with reference to a sequence. FIG. 13 illustrates a sequence example for describing delivery of an ETWS message according to the first embodiment.

In the sequence of FIG. 13, a description is given of a wireless system including a terminal (UE) 200, two base stations, i.e., the source base station (Source HeNB) 100 and the target base station (Target HeNB) 500, higher-level devices including the MME 300 and the HeNB GW 400 indicated in FIG. 12, and additionally including the CBC (Cell Broadcast Center) 600 and the CBE (Cell Broadcast Entity) 700.

First, the CBE 700 outputs a request to deliver an emergency information flash report to CBC (step S51). Next, the CBC 600 that has received the request from the CBE 700 creates a message to be delivered to the terminal 200 from the information included in the request, and specifies the delivery area (step S52). Next, the CBC 600 sends, to the MME 300 of the specified area, a Write-Replace Warning Request message including, for example, the type of disaster, the main text of the message, a delivery area, and a primary notification (step S53).

The MME 300 that has received a Write-Replace Warning Request message notifies the CBC 600 that the message has been received (step S54). Furthermore, the CBC 600 notifies the CBE 700 of an emergency information delivery response indicating that a delivery request has been received and a process has started (step S55).

The MME 300 confirms the delivery area (step S56), and when a list of TAI (Tracking Area Identifier) is included, the MME 300 transfers the Write-Replace Warning Request message only to a base station (hereinafter, the “source base station 100” is taken as an example of the base station) belonging to the corresponding TAI area via the HeNB GW 400 (steps S57, S58). In the process of step S58, when a list of TAI is not set, the MME 300 transfers the Write-Replace Warning Request message to all of the base stations belonging to the MME 300.

Next, the source base station 100, which has received the Write-Replace Warning Request message from the MME 300, determines the delivery area based on the information set in the Write-Replace Warning Request message (step S59), sends a paging signal (ETWS) to the terminal (UE) 200 present in the determined delivery area (step S60), and performs broadcasting according to broadcast information (step S61).

Furthermore, when the transmission is completed, the source base station 100 returns the results to the MME 300 as a Write-Replace Warning response via the HeNB GW 400 (steps S62, S63).

In the above process, when starting transmission of emergency information, the source base station 100 sends, to a terminal, a paging signal in which an ETWS indication is set. The terminal corresponding to ETWS attempts to receive paging signals at a Default Paging Cycle (for example, 320 msec, 640 msec, 1.28 sec, 2.56 sec), regardless of whether the state of the terminal 200 is idle (standby) or RRC connected (communicating). When an ETWS indication is set in the paging signal, the reception of emergency information is started. The ETWS indication is set so as to be repeatedly transmitted at all paging transmission timings, and to reliably reach the terminal.

The above example describes a case where handover from the base station to which the terminals has been connected, to the HeNB for which CSG communication has been released, in response to receiving the release of CSG communication.

However, there may be a case where the terminal is not connected to another base station until a CSG release notification is received. In this case, the control with respect to handover is not performed, and therefore in the architecture of FIG. 5, the processes performed by the HO control unit 106 and the HO control signal creating unit 107 are not performed.

Sequence: Case without Handover

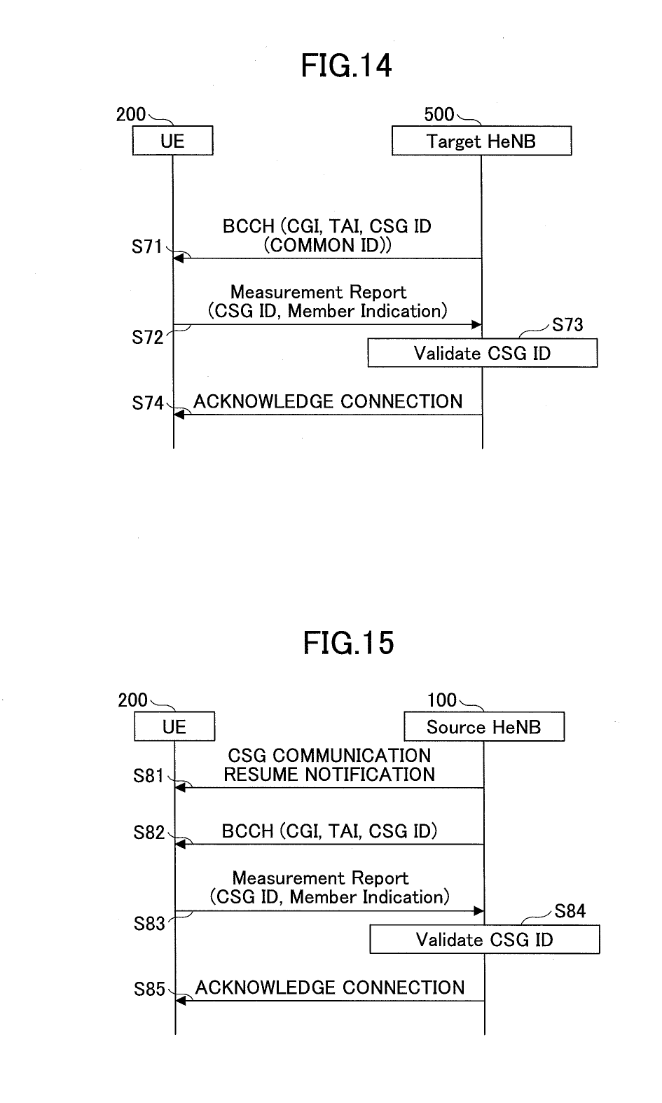

FIG. 14 illustrates a sequence example where the connection is directly set without handover to HeNB performing communication by CSG procedures. “Communication by CSG procedures” means “communication using CSG functions”. FIG. 14 indicates the process between the target base station 500, which is one example of a base station, and the terminal 200.

The target base station (target HeNB) 500 sends, to the terminal 200, system information such as CGI (Cell Global Identifier) as BCCH, TAI (Tracking Area Identifier), and CSG ID (common) (step S71).

The terminal 200 notifies the target base station 500 of the CGI, the TAI, and the CSG ID obtained from the target base station 500, and a measurement result (measurement report) including information of a member indication of CSG (step S72).

Next, the target base station 500 confirms whether the received CSG ID matches the CSG ID broadcast at step S71. When the CSG IDs match, the target base station 500 determines that the received CSG ID is valid and assigns an appropriate resource (step S73), and sends a connection acknowledgement to the terminal 200 (step S74).

Accordingly, the connection is directly set without the handover, and the above ETWS message delivery is received.

Example of Resuming CSG Communication after Release of CSG Communication in Modification Example 1

When completion of transmission of a paging signal that is a first notification of ETWS and an ETWS message that is a second notification is detected, a notification is made to the terminal to resume communication by CSG procedures.

FIG. 15 illustrates a sequence example of reconnection of CSG according to modification example 1. FIG. 15 illustrates control at the terminal 200 and the source base station 100.

In FIG. 15, first, the source base station 100 notifies a CSG communication resume notification (step S81). Subsequently, the source base station 100 sends, to the terminal 200, system information such as CGI (Cell Global Identifier) as BCCH, TAI (Tracking Area Identifier), and CSG ID (step S82).

The terminal 200 notifies the source base station 100 of the CGI, the TAI, and the CSG ID obtained from the source base station 100, and a measurement result (measurement report) including information of a member indication of CSG (step S83).

Next, the source base station 100 confirms whether the received CSG ID matches the CSG ID broadcast at step S82. When the CSG IDs match, the source base station 100 determines that the received CSG ID is valid and assigns an appropriate resource (step S84), and sends a connection acknowledgement to the terminal 200 (step S85).

Example of Resuming CSG Communication after Release of CSG Communication in Modification Example 2

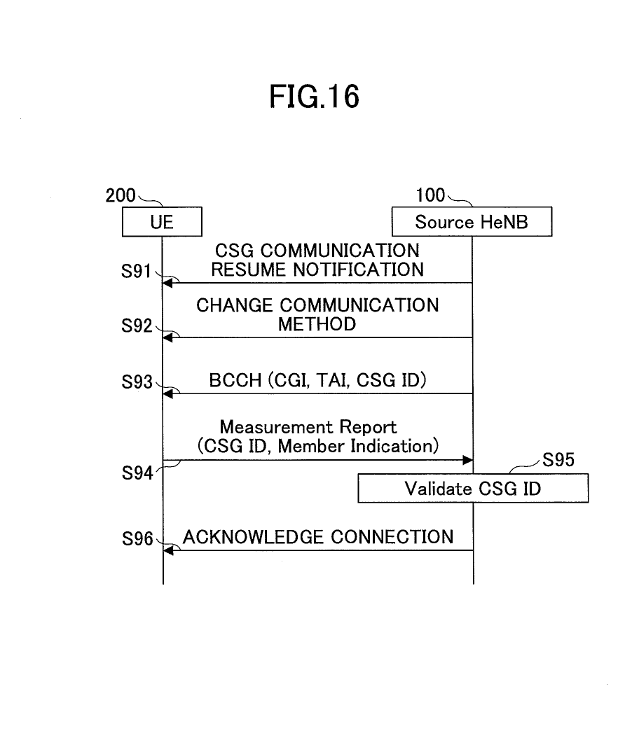

FIG. 16 illustrates a sequence example of reconnection of CSG according to modification example 2. FIG. 16 illustrates control example at the terminal 200 and the source base station 100. Compared to the example of FIG. 15, in the example of FIG. 16, first, the source base station 100 notifies a CSG communication resume notification (step S91), and then sends a communication method change signal to the terminal (step S92). The subsequent processes of steps S93 through S96 are the same as the processes of steps S82 through S85 described above.

That is to say, in the first embodiment, the broadcast of a warning message is started after a notification is sent indicating that a base station starts to broadcast a warning message by non-specific communication to a terminal with which communication is possible. Therefore, a warning message is quickly and reliably notified to the terminal.

### Second Embodiment

Next, a description is given of a second embodiment. In the second embodiment, the source base station 100 communicating with the terminal 200 by CSG procedures, receives, from the network (MME 300), an ETWS transmission request (Write-Replace Warning Request) via a predetermined interface. The source base station 100 recognizes that this is a delivery area of the ETWS message. In a case of delivering an ETWS message, the source base station 100 transmits a paging signal and a message of ETWS, with the use of a special CSG ID (for example, a common CSG ID) for allowing communication for all terminals in the service area.

The special CSG ID may be commonly used by terminals within the same communication service operator (hereinafter, “operator”), or commonly used by all terminals regardless of the operator, or commonly used by all terminals in different countries.

The special CSG ID may be stored in advance in the terminal, or may be notified as system information (SIB) from the network side or the base station when setting the wireless channel. The terminal 200, which has received a notification that communication by CSG procedures is to be performed by using a special CSG ID, uses this special CSG ID to establish a wireless channel with HeNB.

After the establishment, the source base station 100 transmits a paging signal of ETWS or an ETWS message to the terminal 200 in the service area of the source base station 100, similar to the first embodiment. The paging signal and the ETWS message is repeatedly transmitted for a predetermined time period.

The terminal 200 receives the paging signal of ETWS, and performs a process of buzzing a buzzer. Furthermore, the terminal 200 receives the ETWS message, and displays the message on the screen of a terminal.

Furthermore, when the period of transmitting the paging signal and message of ETWS ends, a notification is made to the terminal 200 in the service area of HeNB to stop using the special CSG ID. This notification may be made by using a paging channel (PCH) as a paging signal, and a downlink shared wireless channel (Physical Downlink Shared Channel: PDSCH) or a broadcast channel (Physical Broadcast Channel: PBCH) as the system control information, similar to the case of starting to use the special CSG ID.

Furthermore, in order to resume communication by CSG procedures, the HeNB notifies the CSG ID with the use of a paging channel, and establishes a wireless channel with the terminal belonging to CSG.

### Second Embodiment: Communication Process Example of Base Station

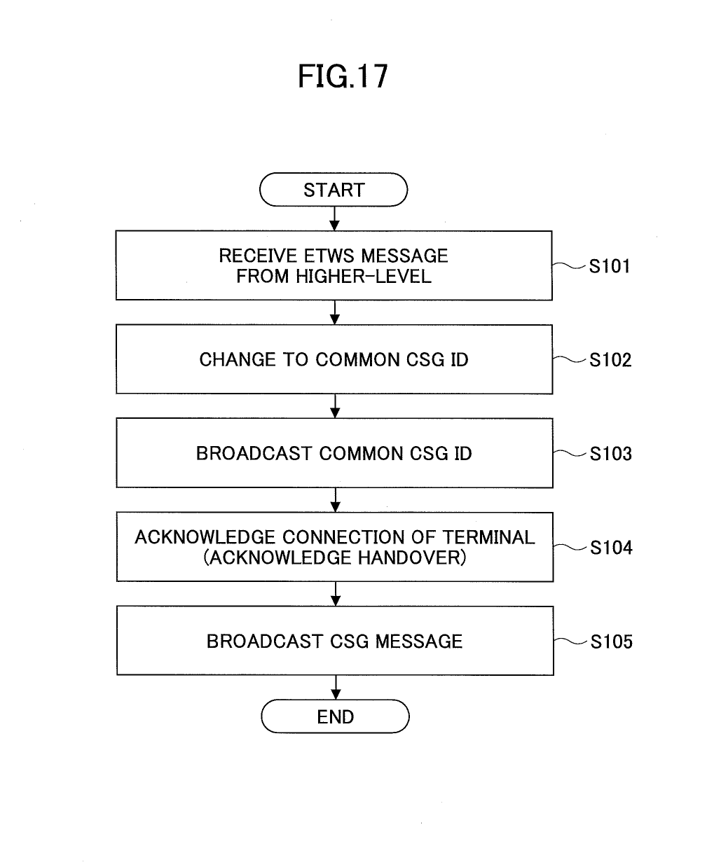

A detailed description is given of an example of transmitting ETWS to all terminals with the use of the special CSG ID, as a communication process procedure of the base station according to the second embodiment. FIG. 17 is a flowchart example illustrating a communication process of a base station according to the second embodiment. In FIG. 17, when an ETWS message is received from a higher-level device (step S101), the base station changes the CSG ID to a common CSG ID (step S102), and broadcasts the common CSG ID to the terminals (step S103). Next, when the base station acquires a terminal connection acknowledgment (handover acknowledgment) (step S104), the base station broadcasts a CSG message (step S105). In step S104, all terminals are allowed to be connected, and therefore the connection acknowledgment determination is not performed.

### Second Embodiment: Communication Process Example of Base Station (Modification Example 1)

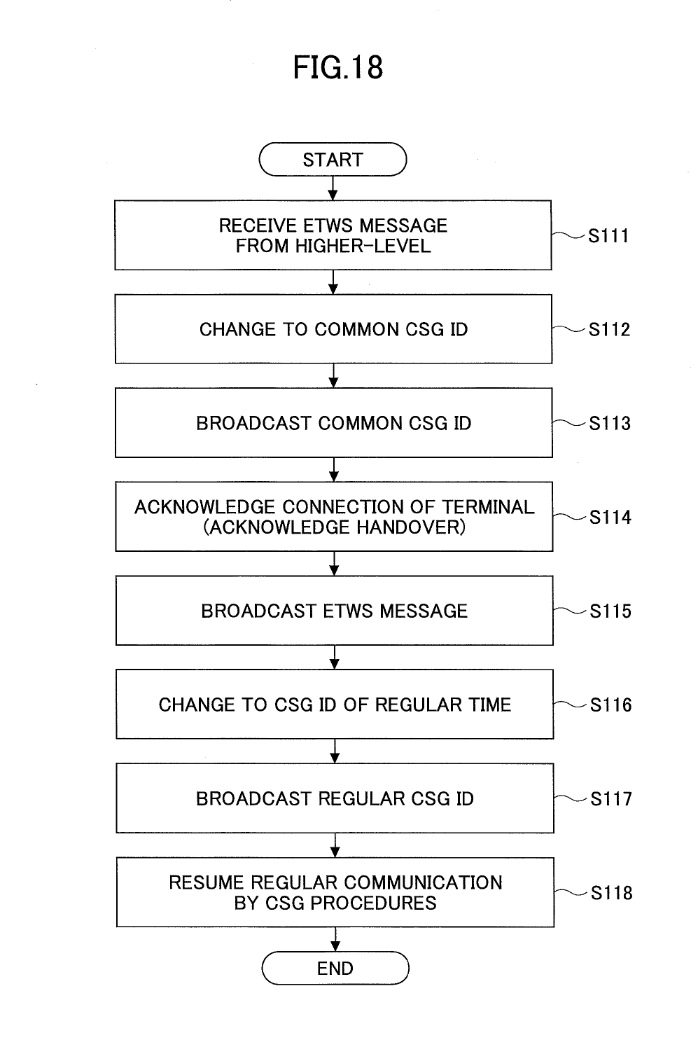

FIG. 18 is a flowchart example illustrating a communication process of a base station according to the second embodiment (modification example 1). FIG. 18 also illustrates an example of processing procedures including the process of resuming regular CSG communication. In the process of FIG. 18, steps S111 through S115 are the same as steps S101 through S105 of FIG. 17, and therefore specific descriptions are omitted.

After step S115, the base station changes the common CSG ID to a regular CSG ID (step S116), broadcasts the regular CSG ID (step S117), and subsequently resumes communication with the regular CSG ID (step S118).

### Second Embodiment: Block Architecture Example of Source Base Station 100

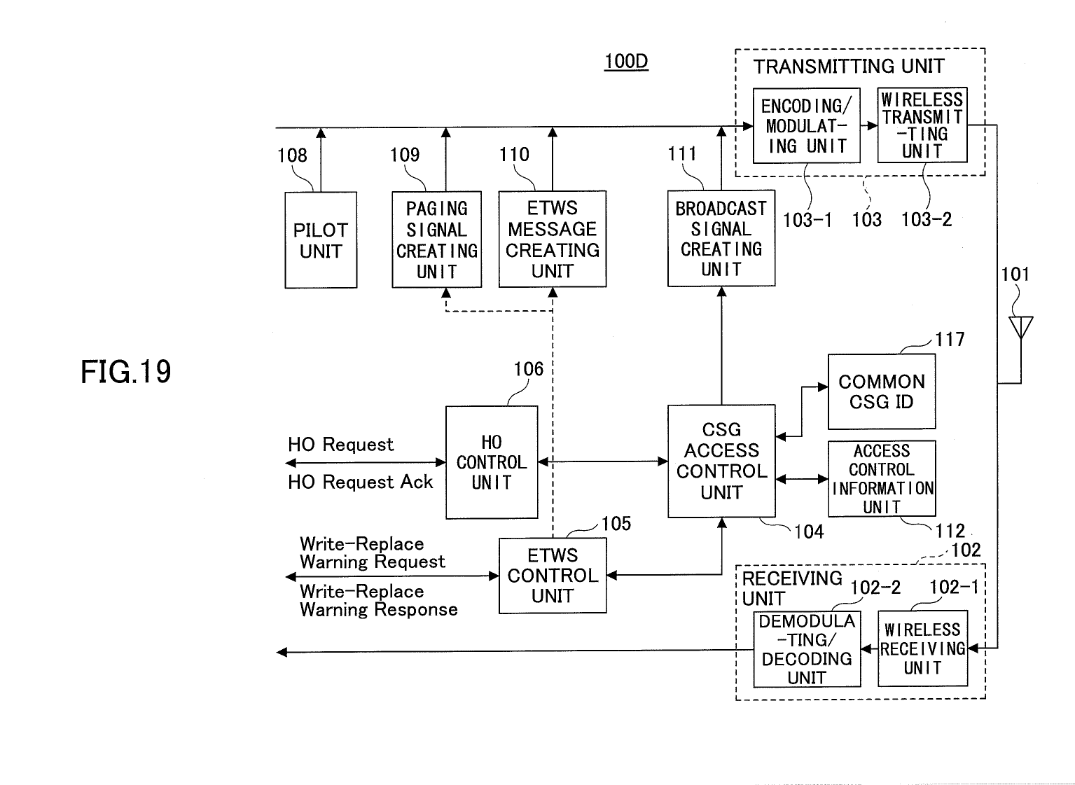

Next, a description is given of a block architecture example of the source base station 100 according to the second embodiment, with reference to FIG. 19. FIG. 19 illustrates a block architecture example of the source base station 100 according to the second embodiment. In FIG. 19, the blocks having the same functions as the blocks illustrated in FIG. 5 of the first embodiment are denoted by the same reference numerals and specific descriptions are omitted.

A source base station 100D illustrated in FIG. 19 includes the antenna unit 101, the receiving unit 102, the transmitting unit 103, the CSG access control unit 104, the ETWS control unit 105, the HO control unit 106, the HO control signal creating unit 107, the pilot unit 108, the paging signal creating unit 109, the ETWS message creating unit 110, and the broadcast signal creating unit 111.

In FIG. 19, a common CSG ID 117 (second identification information) is newly added to the source base station 100A of FIG. 5. That is to say, in the second embodiment, the CSG access restriction is released with the use of the common CSG ID 117. Therefore, when an ETWS message is to be transmitted, the CSG access control unit 104 sends the common CSG ID 117 to the broadcast signal creating unit 111. The broadcast signal creating unit 111 generates a signal for broadcasting the common CSG ID 117 to the target terminals 200, and sends the generated common CSG ID 117 to the terminals 200.

The common CSG ID may be recorded in advance in the terminal 200 as common CSG ID of the wireless system 10, or may be notified to the terminal 200 as system information at the time of channel setup; however, the present invention is not so limited. For example, a unique CSG ID for each communication operator may be used, or a CSG ID commonly used by all countries may be used.

### Second Embodiment: Block Architecture Example of Source Base Station 100 (Modification Example 1)

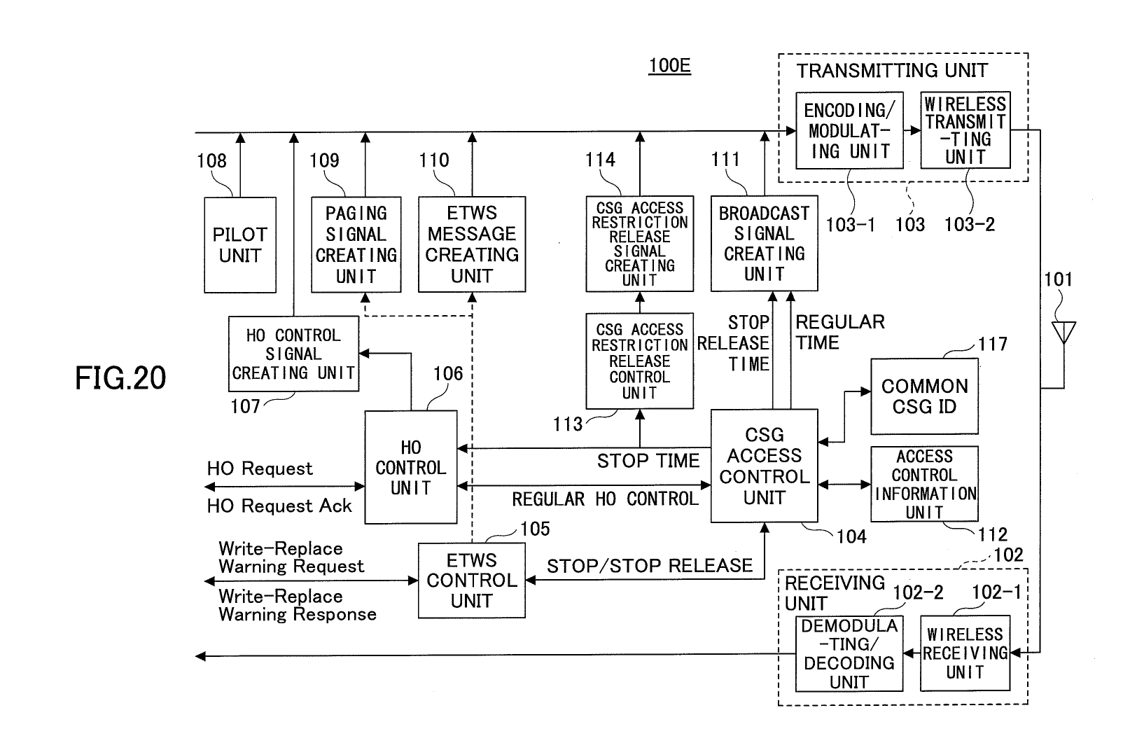

FIG. 20 illustrates a block architecture example of a base station according to the second embodiment (modification example 1). In FIG. 20, the blocks having the same functions as the blocks illustrated in FIG. 6 of modification example 1 of the first embodiment are denoted by the same reference numerals and specific descriptions are omitted.

A source base station 100E illustrated in FIG. 20 includes the antenna unit 101, the receiving unit 102, the transmitting unit 103, the CSG access control unit 104, the ETWS control unit 105, the HO control unit 106, the HO control signal creating unit 107, the pilot unit 108, the paging signal creating unit 109, the ETWS message creating unit 110, the broadcast signal creating unit 111, the CSG access restriction release control unit 113, and the CSG access restriction release signal creating unit 114.

In FIG. 20, a common CSG ID 117 is newly added to the architecture of FIG. 6. That is to say, in the base station architecture of FIG. 20, in the CSG access restriction release signal creating unit 114, a CSG control release signal is created based on the common CSG ID 117, and the signal is transmitted to the terminal 200 (note that the common CSG ID 117 itself may be used as the CSG control release signal). Subsequently, the same operations as those described above are performed, and the ETWS message is received.

Furthermore, after the transmission of a paging signal of ETWS and an ETWS message has been completed, the ETWS control unit 105 notifies the CSG access control unit 104 that the transmission of a paging signal of ETWS and an ETWS message has been completed. The CSG access control unit 104 that has received the notification performs control to resume CSG communication. The control of resuming CSG communication is the same as modification example 1 of the first embodiment, and therefore specific descriptions are omitted.

### Second Embodiment: Block Architecture Example of Terminal

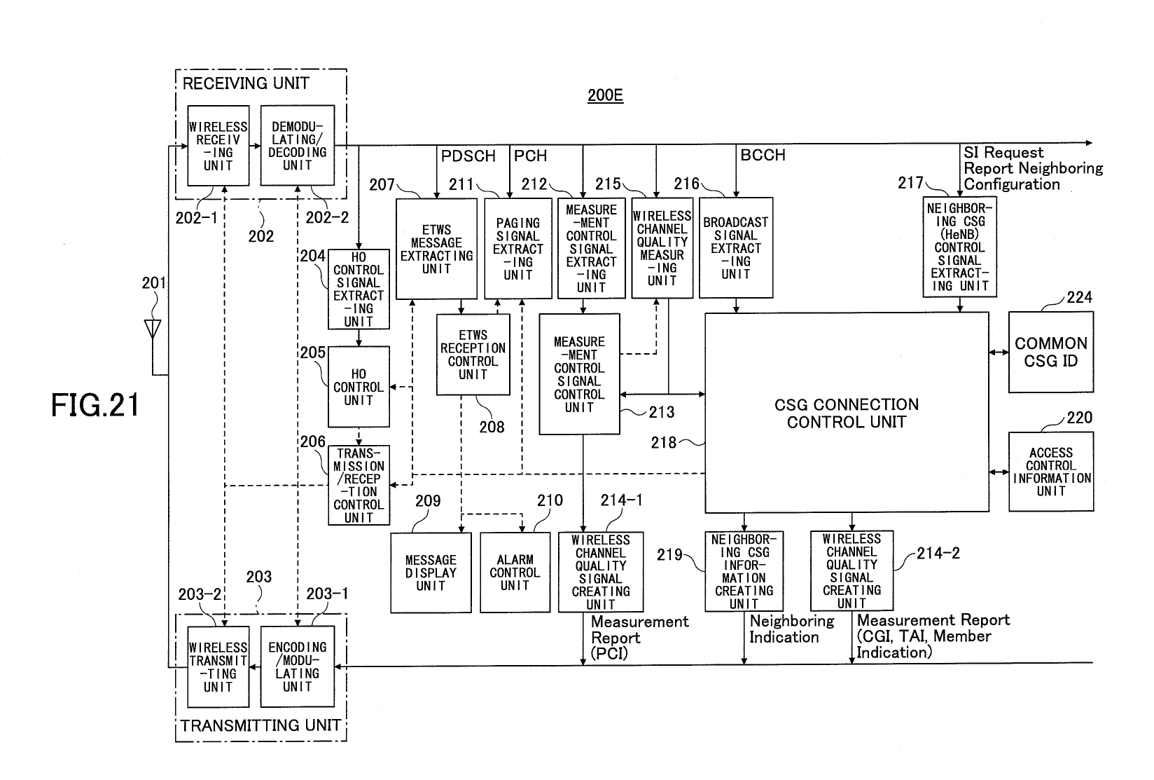

FIG. 21 illustrates a block architecture example of the terminal 200 according to the second embodiment. The blocks having the same functions as the blocks of the terminals 200 described above are denoted by the same reference numerals and specific descriptions are omitted.

A terminal 200E illustrated in FIG. 21 includes an antenna unit 201, a receiving unit 202, a transmitting unit 203, a HO control signal extracting unit 204, a HO control unit 205, a transmission/reception control unit 206, an ETWS message extracting unit 207, an ETWS reception control unit 208, a message display unit 209, an alarm control unit 210, a paging signal extracting unit 211, a measurement control signal extracting unit 212, a measurement control signal control unit 213, wireless channel quality signal creating units 214-1, 214-2, a wireless channel quality measuring unit 215, a broadcast signal extracting unit 216, a neighboring CSG (HeNB) control signal extracting unit 217, a CSG connection control unit 218, and a neighboring CSG information creating unit 219.

That is to say, in the terminal 200E illustrated in FIG. 21, a common CSG ID 224 is further added to the terminal 200A (FIG. 8) according to the first embodiment. In the architecture of FIG. 21, the broadcast signal extracting unit 216 extracts a CSG ID from the received signal, and outputs the CSG ID to the CSG connection control unit 218.

The CSG connection control unit 218 that has received the notification of CSG ID compares the CSG ID with the common CSG ID 224, and when they match, the CSG connection control unit 218 recognizes that the CSG communication has been practically released, and performs control to connect to the base station (HeNB) by using the common CSG ID 224.

Furthermore, the CSG connection control unit 218 requests the HO control unit 205 to perform HO, and the HO control unit 205 performs handover, and connects to the target base station 500 (or the source base station 100). Subsequently, the ETWS message is received in a similar manner as the above.

### Second Embodiment: Block Architecture Example of Terminal 200 (Modification Example 1)

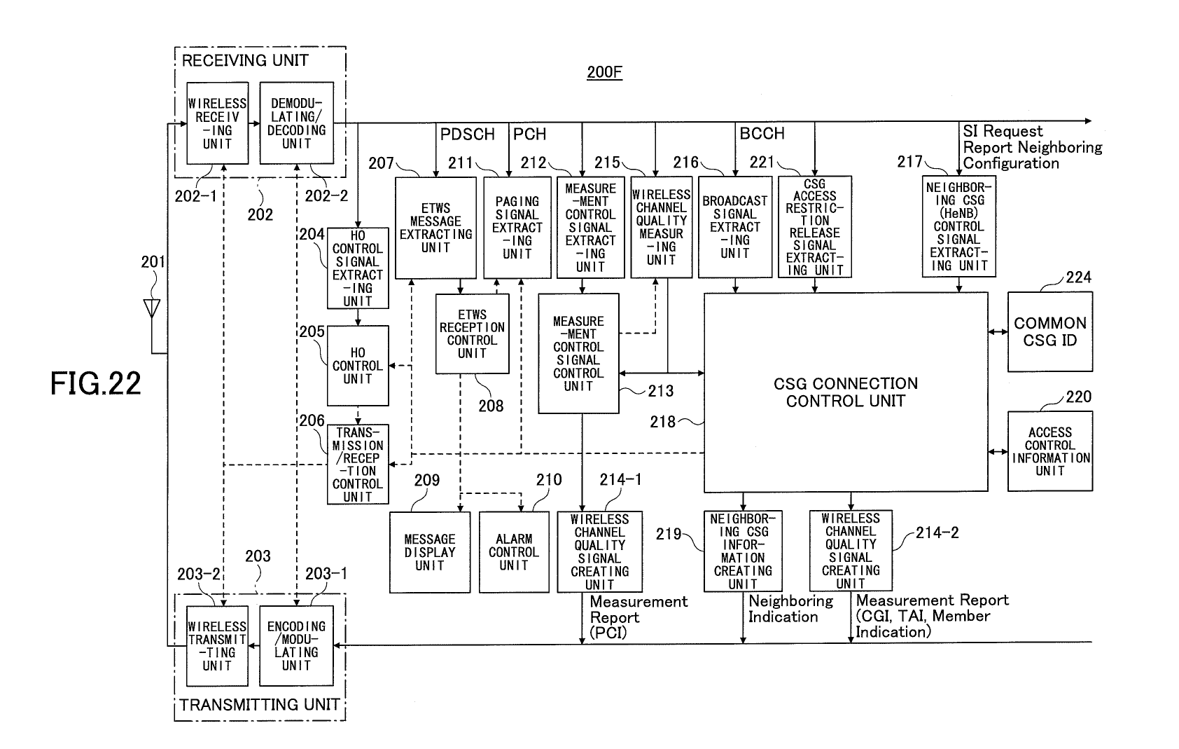

FIG. 22 illustrates a block architecture example of the terminal 200 according to the second embodiment (modification example 1). The blocks having the same functions as the blocks of the terminal 200E according to the second embodiment are denoted by the same reference numerals and specific descriptions are omitted.

A terminal 200F illustrated in FIG. 22 includes an antenna unit 201, a receiving unit 202, a transmitting unit 203, a HO control signal extracting unit 204, a HO control unit 205, a transmission/reception control unit 206, an ETWS message extracting unit 207, an ETWS reception control unit 208, a message display unit 209, an alarm control unit 210, a paging signal extracting unit 211, a measurement control signal extracting unit 212, a measurement control signal control unit 213, wireless channel quality signal creating units 214-1, 214-2, a wireless channel quality measuring unit 215, a broadcast signal extracting unit 216, a neighboring CSG (HeNB) control signal extracting unit 217, a CSG connection control unit 218, a neighboring CSG information creating unit 219, and a CSG access restriction release signal extracting unit 221.

In the terminal architecture of FIG. 22, the CSG access restriction release signal extracting unit 221 extracts, from the received signal, a CSG access control signal created based on the common CSG ID, and outputs the extracted CSG access control signal to the CSG connection control unit 218.

The CSG connection control unit 218 compares the CSG access control signal with the common CSG ID 224 stored in advance, and when they match, the CSG connection control unit 218 recognizes that the CSG communication has been released, and performs control to connect to HeNB by using the common CSG ID 224. Furthermore, the CSG connection control unit 218 requests the HO control unit 205 to perform HO, and the HO control unit 205 performs handover, and connects to the source base station 100. Subsequently, the ETWS message is received in a similar manner as the above.

### Sequence According to Second Embodiment

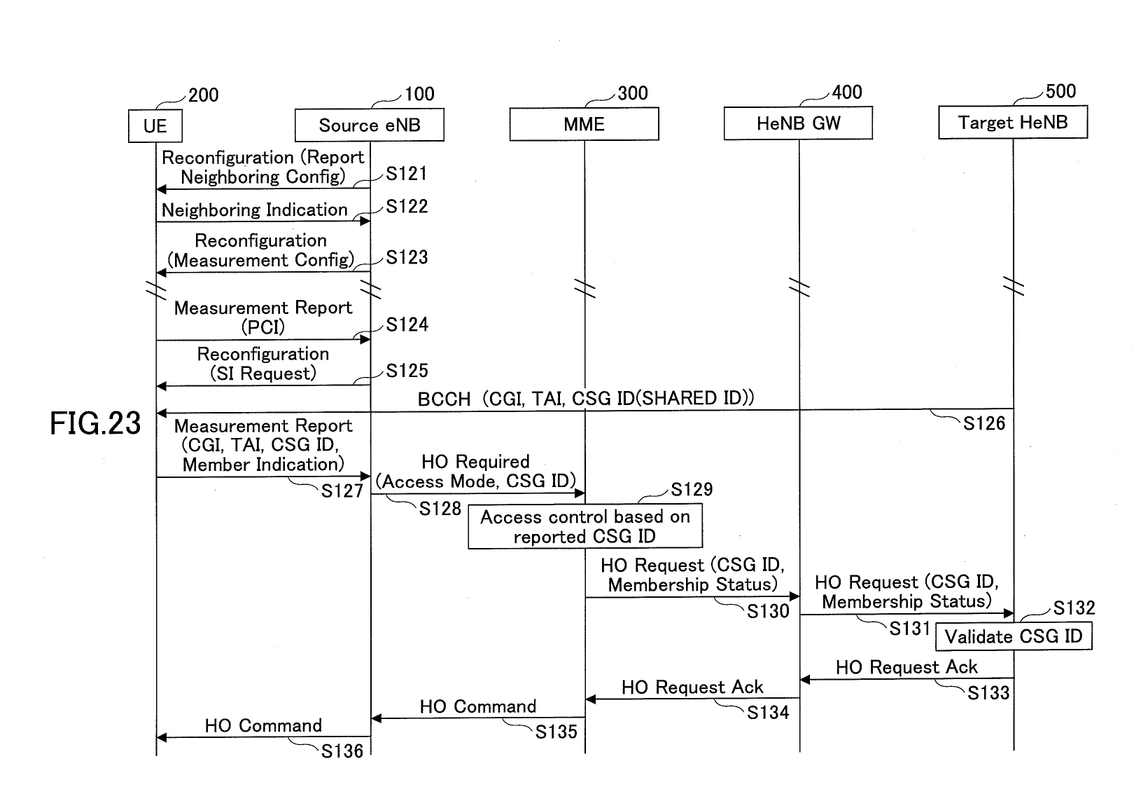

Next, a description is given of a sequence example according to the second embodiment. FIG. 23 illustrates a sequence example of handover according to the second embodiment.

In the example of FIG. 23, a description is given of a wireless system including a terminal (UE) 200, two base stations, i.e., the source base station (Source HeNB) 100 and the target base station (Target HeNB) 500, and higher-level devices including the MME 300 and the HeNB GW 400.

First, the source base station 100 notifies the terminal 200 of information of an adjacent CSG cell (Report Neighboring Architecture) (step S121). The Neighboring Architecture is different from an adjacent cell list which is a list of base stations adjacent to a particular base station.

Next, the terminal (UE) 200 notifies the source base station (Source HeNB) 100 to which the terminal (UE) 200 is connected, that the terminal (UE) 200 is approaching the Femto cell having a CSG ID of a CSG list (for example, a white list) to which the terminal (UE) 200 may be connected (step S122).

When the terminal 200 does not have a measurement condition with respect to RAT and the frequency used by CSG procedures, the source base station 100 notifies control information (Measurement Architecture) such as a measurement condition from the base station to which the terminal 200 is connected (step S123).

The terminal 200 includes a physical cell ID (PCI) in the result measured with the use of the notified control information, and notifies the result to the source base station 100 to which the terminal 200 is connected (step S124).

The source base station 100 sets the terminal 200 so as to be capable of acquiring system information of a particular physical cell ID (PCI) and capable of reporting the information (step S125).

In this case, the target base station 500 that is the HO destination HeNB sends, to the terminal 200, system information such as CGI, TAI, and CSG ID sent by BCCH (step S126).

The terminal 200 notifies the source base station 100, which is the HO source base station, of the measurement results including CGI, TAI, CSG ID, and a member indication of CSG (step S127). The source base station 100 outputs, to the MME 300, the Handover Request message including CGI and CSG ID (step S128). When the target base station 500 is of a Hybrid cell described below, the connection mode (CSG or public) is also sent together in the message.

The MME 300 performs control to handover the terminal 200 to the CSG cell of the CSG ID included in the received Handover Request message (step S129). Furthermore, the MME 300 stores the signature of CSG for the terminal 200 in the process of step S129.

The MME 300 outputs the Handover Request message to the CSG cell of the CSG ID included in the received Handover Request message, via the HeNB GW 400 (steps S130, S131).

The target base station 500 confirms whether the CSG ID of the received Handover Request message matches the CSG ID broadcast from the target base station 500, and when they match, the target base station 500 assigns an appropriate resource (step S132). In the process of step S132, when the CSG Membership status indicates that the terminal is a member of the CSG, the order of the terminal may be prioritized.

The target base station 500 sends a Handover Request Acknowledge message to the MME 300 via the HeNB GW 400 (steps S133, S134). The MME 300 sends a Handover Command message to the source base station 100 (step S135).

The source base station 100 sends a Handover Command (a RRC Connection Reconfiguration message including mobility control information) to the terminal 200 (step S136).

As described above, by using a common CSG ID, communication is easily performed. Furthermore, the sequence in the case of resuming CSG communication is the same as the first embodiment, and therefore specific descriptions are omitted.

As described above, in the second embodiment, a common CSG ID is set in all terminals and in all areas, and the common CSG ID is used when notifying an ETWS message. The common CSG ID may be notified to the terminal, or the terminal may hold the CSG ID as an initial value.

### Third Embodiment

Next, a description is given of a third embodiment. The third embodiment includes a HeNB (hereinafter, “Hybrid HeNB”), which is capable of performing both communication by CSG procedures (hereinafter, abbreviated as “CSG mode”) and regular communication (i.e., a communication method of not allowing connection only for a particular terminal but allowing connection from all terminals; a so-called public communication method; hereinafter, abbreviated as “public mode”). That is to say, in the third embodiment, an ETWS transmission request (Write-Replace Warning Request) is received from a network (for example, the MME 300) via an interface. Furthermore, in the third embodiment, the base station recognizes that this is a delivery area of the ETWS message. In a case of delivering an ETWS message, the source base station prioritizes ETWS message transmission, and temporarily stops the CSG mode for the terminal 200 communicating at this time point, and only performs the public mode.

Accordingly, an ETWS message is transmitted to terminals inside the service area of the base station. At the Hybrid HeNB, for example, control is performed to prioritize the CSG mode and to switch to the public mode when there is excess in the wireless resource. That is to say, the Hybrid HeNB operates to prioritize the connection of a terminal belonging to CSG. This is done in order to prioritize connection of terminals belonging to CSG from the view point that usage by the installation personnel bearing the burden of the installation cost of the base station (HeNB) is to be prioritized. In other words, the wireless resource to be assigned to the terminal belonging to the CSG is secured, and when there is excess in the wireless resource, the excessive resource is used for operating in the public mode, so that other terminals not belonging to CSG may be connected.

In the above-described Hybrid HeNB, when a message of an emergency warning system such as ETWS is transmitted, from the view point of respecting human life, the ratio of operating in the CSG mode and the public mode (i.e., the ratio of the wireless resource used in the CSG mode and the wireless resource used in the public mode) is changed. For example, in the third embodiment, the ratio of the CSG mode and the public mode is 0:10. This means that the CSG mode is temporarily stopped. Furthermore, the method of stopping communication by CSG procedures is the same as that of the first embodiment.

The above-described wireless resource is a grid constituted by a time area and a frequency area (i.e., sub carrier) in the LTE system, and the minimum unit is referred to as RB (Resource Block).

### Third Embodiment: Communication Process Example of Base Station

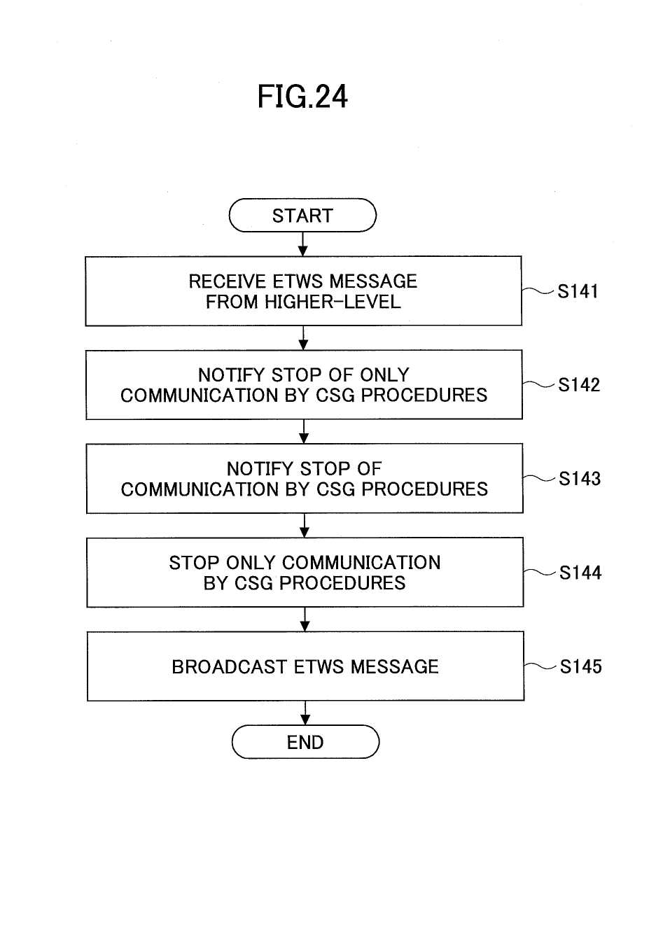

A detailed description is given of a communication process procedure of the base station according to the third embodiment with reference to a flowchart. FIG. 24 is a flowchart example illustrating a communication process of a base station according to the third embodiment. In the processing procedure of FIG. 24, first, when the source base station 100 receives an ETWS message from a higher-level device (for example, MME 300) (step S141), next, the source base station 100 makes a notification to stop only the communication by CSG procedures (step S142). Furthermore, the source base station 100 makes a notification to stop the communication by CSG procedures (step S143), and stops only the communication by CSG procedures (step S144). Subsequently, the source base station 100 broadcasts the ETWS message to the terminal 200 (step S145).

### Third Embodiment: Communication Process Example of Base Station (Modification Example 1)

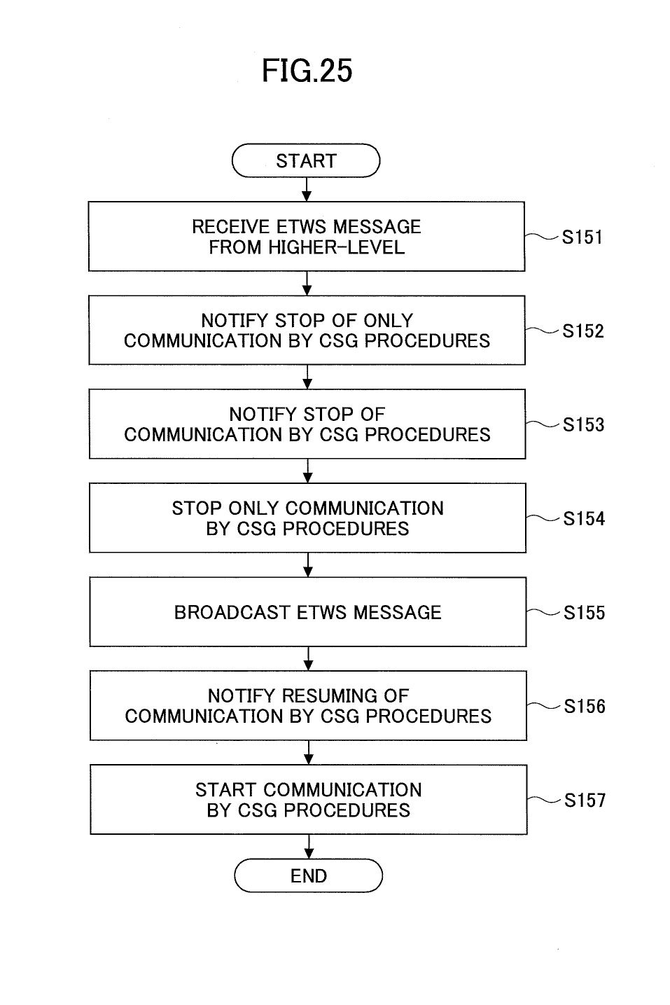

A detailed description is given of a communication process procedure of the base station according to the third embodiment (modification example 1) with reference to a flowchart. FIG. 25 is a flowchart example illustrating a communication process of a base station according to the third embodiment (modification example 1). FIG. 25 is a flowchart for describing modification example 1 of the third embodiment. Steps S151 through S155 in FIG. 25 are the same as steps S141 through S145 described above in FIG. 24, and therefore specific descriptions are omitted.

After the process of step S145, the source base station 100 notifies the terminal 200 of the resuming of communication by CSG procedures (step S156), and starts communication by CSG procedures (step S157).

### Third Embodiment: Block Architecture Example of Base Station

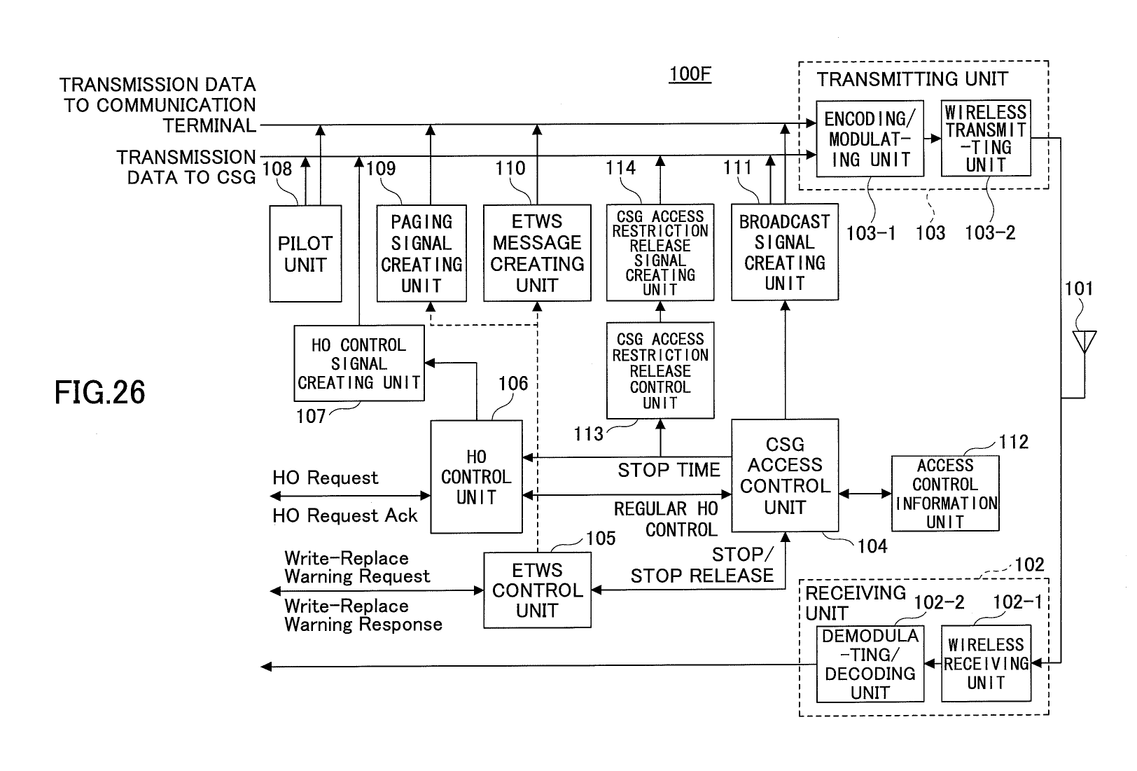

Next, a description is given of a block architecture example of the base station according to the third embodiment, with reference to FIG. 26. FIG. 26 illustrates a block architecture example of a base station according to the third embodiment.

In the block architecture of FIG. 26, the blocks having the same functions as the blocks of the base stations of the embodiments described above are denoted by the same reference numerals and specific descriptions are omitted.

A source base station 100F illustrated in FIG. 26 includes the antenna unit 101, the receiving unit 102, the transmitting unit 103, the CSG access control unit 104, the ETWS control unit 105, the HO control unit 106, the HO control signal creating unit 107, the pilot unit 108, the paging signal creating unit 109, the ETWS message creating unit 110, the broadcast signal creating unit 111, the CSG access restriction release control unit 113, and the CSG access restriction release signal creating unit 114.

In the base station architecture of FIG. 26, when the ETWS control unit 105 receives a request to transmit an ETWS message, the ETWS control unit 105 requests the CSG access control unit 104 to release CSG communication. Subsequently, similar to the architectures described above, CSG communication is released, and the terminal 200 is once again requested to perform handover. Then, a paging signal (first notification) and an ETWS message (second notification) are sent to the terminal 200 by regular communication.

That is to say, in the third embodiment, the broadcast signal creating unit 111 generates broadcast signals for both the terminal authenticated as CSG and a terminal not belonging to CSG (communication terminal), and outputs the generated signals to the corresponding terminals via the transmitting unit 103.

After releasing CSG communication, when it is detected that the transmission of a paging signal of ETWS and the transmission of an ETWS message have ended, and CSG communication is to be resumed, a signal of the time of stop release is output from the CSG access control unit 104 to the broadcast signal creating unit 111. When a broadcast signal is created, the broadcast signal creating unit 111 outputs the signal only to the transmission data of the terminal not belonging to CSG (regular terminal).

That is to say, in the third embodiment, the control signal for resuming CSG communication is transmitted by regular communication. The architecture of the terminal 200 according to the third embodiment is the same as those of the embodiments described above, and therefore specific descriptions are omitted.

As described above, in the third embodiment, the base station (HeNB) forming CSG changes into a state of a Hybrid cell, in which communication is possible with terminals not belonging to CSG. In this case, for example, the base station may notify all terminals of the shift to a Hybrid cell and that connection is possible, before the transmission of the ETWS message. Furthermore, in the third embodiment, the base station that has received a request to transmit an ETWS message may temporarily function as a hybrid base station (Hybrid HeNB) for performing both CSG communication and regular communication.

### Fourth Embodiment

Next, a description is given of a fourth embodiment. In the fourth embodiment, in the base station capable of performing both the CSG mode and the public mode of the third embodiment, the first notification transmitted as a paging signal has a higher level of urgency, and therefore the first notification is transmitted by CSG procedures to a terminal communicating in the CSG mode, and the first notification is transmitted by regular communication to a terminal communicating in the public mode.

That is to say, the first notification is for notifying emergency evacuation, and to quickly send this notification in order to prevent a disaster, the ratio of the CSG mode and the public mode (for example, 0:10, 2:8) is not changed. That is to say, the mode is not switched in the fourth embodiment.

As to the second notification transmitted subsequently, similar to the third embodiment, the CSG mode is temporarily stopped, the terminal in the CSG mode is shifted to the public mode, and the second notification is transmitted to all terminals in the public mode.

The first notification and the second notification are described in detail in non-patent document 5 indicated above. Particularly, the second notification is information relevant to the earthquake center and the earthquake intensity, which is not prerequisite information for evacuation, and is thus not sent by express compared to the first notification. Therefore, the second notification may be broadcast after switching the mode as described above.

### Fourth Embodiment: Communication Process Example of Base Station

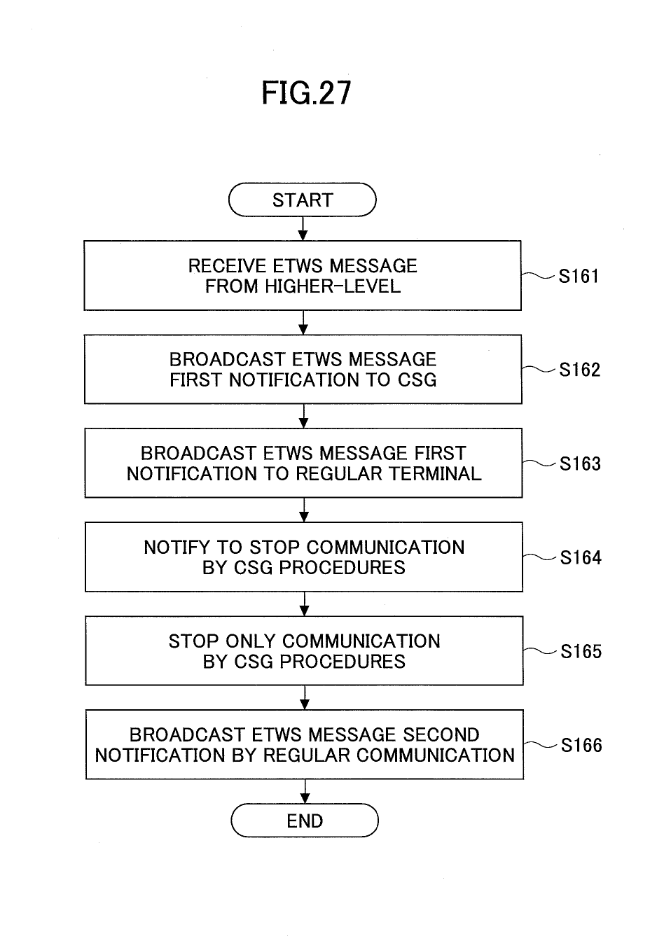

A detailed description is given of a communication process procedure of the base station according to the fourth embodiment with reference to a flowchart. FIG. 27 is a flowchart example illustrating a communication process of a base station according to the fourth embodiment. In the processing procedure of FIG. 27, first, the source base station 100 receives an ETWS message from a higher-level device (step S161), and broadcasts a ETWS message first notification to CSG (step S162), and broadcasts a ETWS message first notification to a regular terminal (step S163). Steps S162 and S163 may be performed in a reverse order or may be performed simultaneously.

Subsequently, the source base station 100 makes a notification to stop the communication by CSG procedures (step S164), and stops only the communication by CSG procedures (step S165). Subsequently, the source base station 100 notifies the ETWS message second notification to both the CSG and the regular terminal by regular communication (step S166).

### Fourth Embodiment: Communication Process Example of Base Station (Modification Example 1)

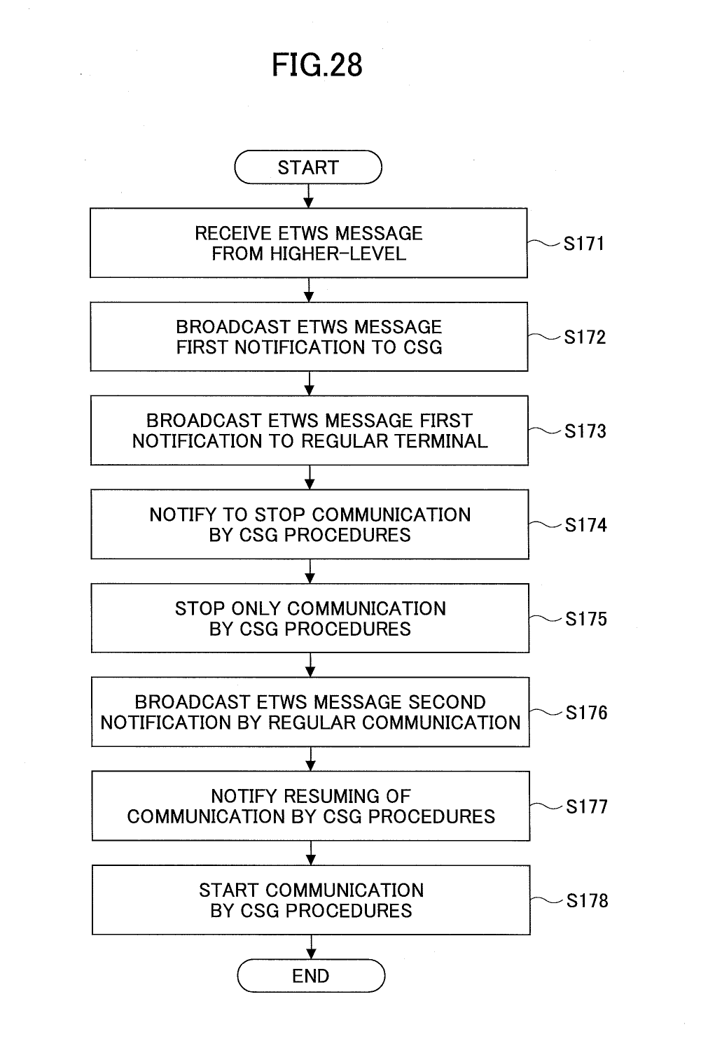

A detailed description is given of a communication process procedure of the base station according to the fourth embodiment (modification example 1) with reference to a flowchart. FIG. 28 is a flowchart example illustrating a communication process of a base station according to the fourth embodiment (modification example 1). Steps S171 through S176 in FIG. 28 are the same as steps S161 through S166 of FIG. 27, and therefore specific descriptions are omitted.

In modification example 1, after the process of step S176 ends, the source base station 100 notifies the resuming of communication by CSG procedures (step S177), and starts communication by CSG procedures (step S178).

### Fourth Embodiment: Block Architecture Example of Base Station

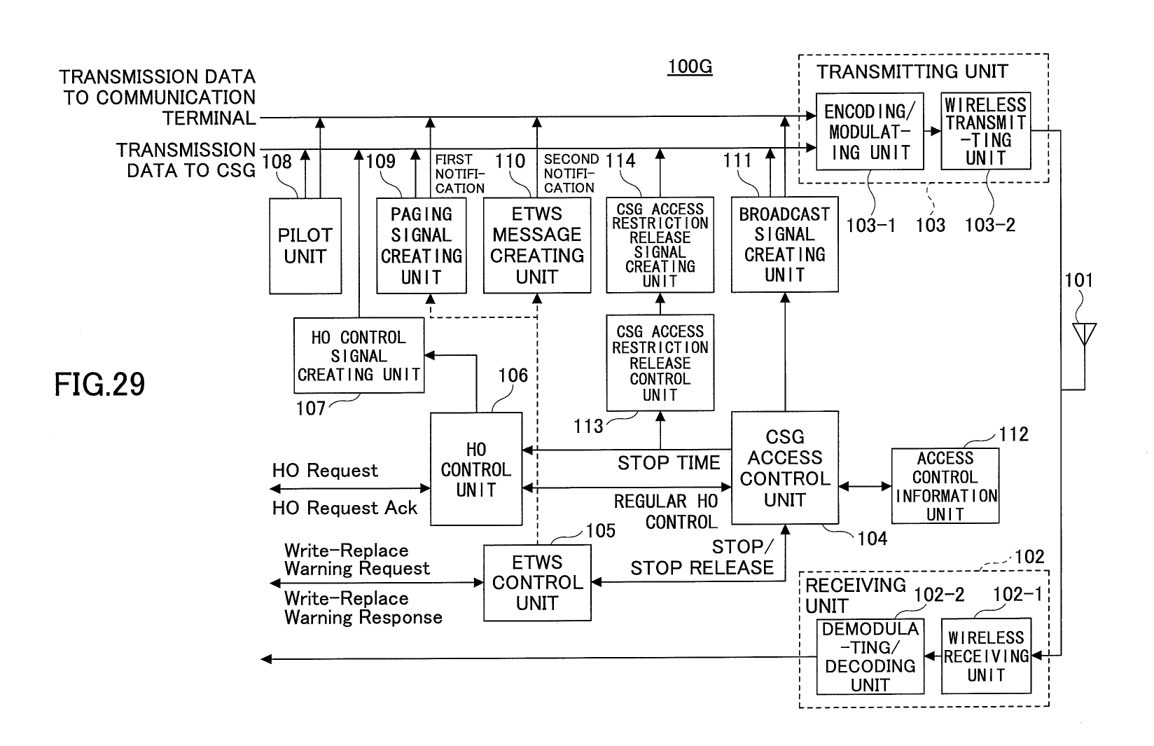

Next, a description is given of a block architecture example of the base station according to the fourth embodiment, with reference to FIG. 29. FIG. 29 illustrates a block architecture example of a base station according to the fourth embodiment. In the block architecture of FIG. 29, the blocks having the same functions as the blocks of the base station of FIG. 26 are denoted by the same reference numerals and specific descriptions are omitted.

A source base station 100G illustrated in FIG. 29 includes the antenna unit 101, the receiving unit 102, the transmitting unit 103, the CSG access control unit 104, the ETWS control unit 105, the HO control unit 106, the HO control signal creating unit 107, the pilot unit 108, the paging signal creating unit 109, the ETWS message creating unit 110, the broadcast signal creating unit 111, the CSG access restriction release control unit 113, and the CSG access restriction release signal creating unit 114.

In the HeNB architecture of FIG. 29, the CSG access control unit 104, which has received a request to release CSG communication from the ETWS control unit 105, performs control to send a notification to release CSG communication to the terminal 200 as described above. Furthermore, the CSG access control unit 104 requests the ETWS control unit 105 to transmit a first notification and a second notification of ETWS.

The ETWS control unit 105 that has received the request performs control to transmit a paging signal that is a first notification of ETWS by both CSG communication and regular communication, and requests the paging signal creating unit 109 to create a first notification. The paging signal creating unit 109 that has received the request creates a first notification, inserts the first notification in both the data to CSG and the transmission data to the regular terminal, and transmits the data.

The ETWS control unit 105 performs control to transmit the ETWS message by regular communication, and requests the ETWS message creating unit 110 to create a second notification. The ETWS message creating unit 110 that has received the request creates the second notification, and inserts the second notification only in the transmission data to the regular terminal, and transmits the data to the terminal 200. The architecture of the terminal 200 according to the fourth embodiment is the same as those of the embodiments described above, and therefore specific descriptions are omitted.

### Fifth Embodiment: Example of Stopping, Continuing, and Resuming Communication by CSG Procedures

Next, a description is given of a fifth embodiment. In the first through fourth embodiments described above, when transmission of a second notification of ETWS is ended, the original communication by CSG procedures is resumed. However, when an earthquake exceeding a predetermined level or an extensive disaster is expected from the contents of the second notification, there is a high possibility of damage and breakdown and interruption of the operation at the base station and the HeNB. Meanwhile, securing a wireless channel is significantly important for use in making subsequent rescue efforts and confirming the whereabouts of missing people. Therefore, it is important to secure many operable base stations and to secure a wireless channel.

Thus, in the fifth embodiment, when an earthquake exceeding a predetermined level or an extensive disaster is expected from the broadcast contents, communication by CSG procedures is not resumed, and regular communication (i.e., allowing connection from terminals; public communication) is continued.

Furthermore, when regular operation becomes possible as the base station recovers, and more than a predetermined amount of the wireless channel may be secured, communication by CSG procedures is notified from the OAM (Operations, Administration, and Maintenance) controlling the system to the base station (HeNB).

The base station that has received the notification notifies a CSG ID to the terminal in the service area of the base station. The terminal that has received the notification cross-checks the notified CSG ID with the stored CSG ID, and when the CSG IDs match, the terminal notifies the HeNB of a connection request including a member indication of CSG.

Furthermore, the base station that has received the connection request confirms that the terminal is a member of CSG, and establishes a wireless channel. Furthermore, the base station and the terminal 200 perform communication by CSG procedures after the wireless channel is established.

### Fifth Embodiment: Communication Process Example of Base Station

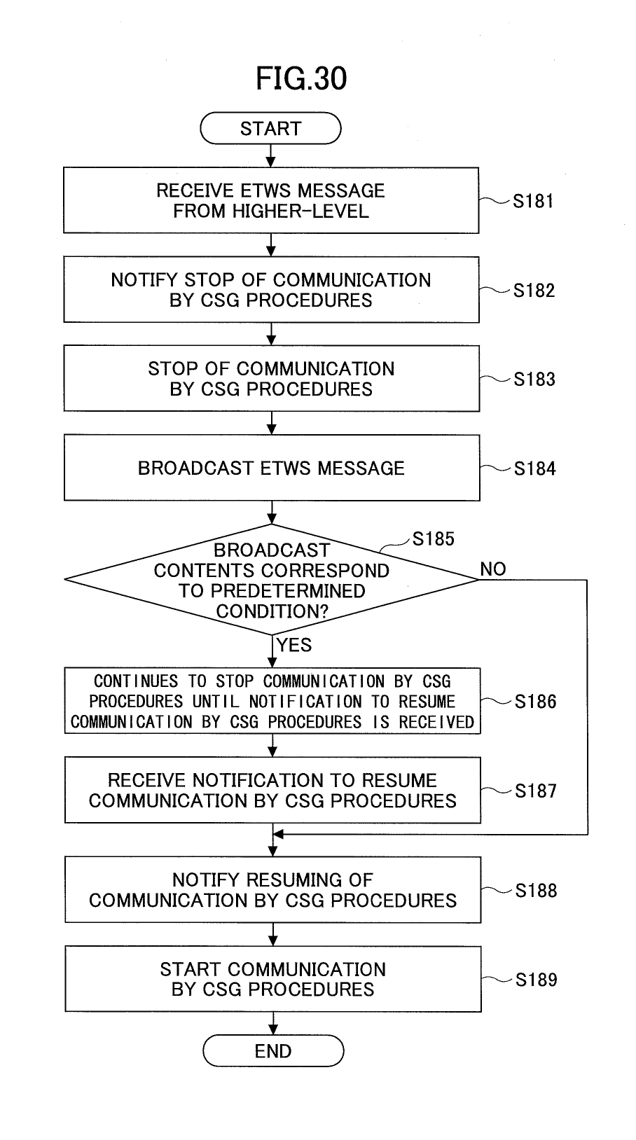

A detailed description is given of a communication process procedure example of the base station according to the fifth embodiment. As one example of the process procedure, the same process as that of the first embodiment (FIG. 4) described above may be performed. FIG. 30 is a flowchart example illustrating a communication process of a base station according to the fifth embodiment.

In the processing procedure example of FIG. 30, when the source base station 100 receives an ETWS message from a higher-level device (for example, MME 300) (step S181), the source base station 100 makes a notification to stop the communication by CSG procedures (step S182).

After notifying to stop communication, the source base station 100 temporarily stops communication by CSG procedures (step S183), and broadcasts an ETWS message (step S184). Next, the source base station 100 determines whether the broadcast contents correspond to a predetermined condition (step S185). For example, when the broadcast contents indicate information relevant to the earthquake intensity, the source base station 100 determines whether the broadcast contents indicate an earthquake intensity exceeding a predetermined level (for example, intensity 6 upper). Then, when the broadcast contents are determined to correspond to a predetermined condition (YES in step S185), the source base station 100H continues to stop the communication by CSG procedures until a notification to resume communication by CSG procedures is received from a network such as OAM (step S186). Then, when a notification to resume communication by CSG procedures is received (step S187), the source base station 100H notifies the resuming of communication by CSG procedures (step S188), and starts communication by CSG procedures (step S189).

Furthermore, in step S185, when the broadcast contents are determined not to correspond to a predetermined condition (for example, the broadcast contents do not indicate an earthquake intensity exceeding a predetermined level) (NO in step S185), the source base station 100H notifies the resuming of communication by CSG procedures (step S188), and starts communication by CSG procedures (step S189).

### Fifth Embodiment: Block Architecture Example of Base Station

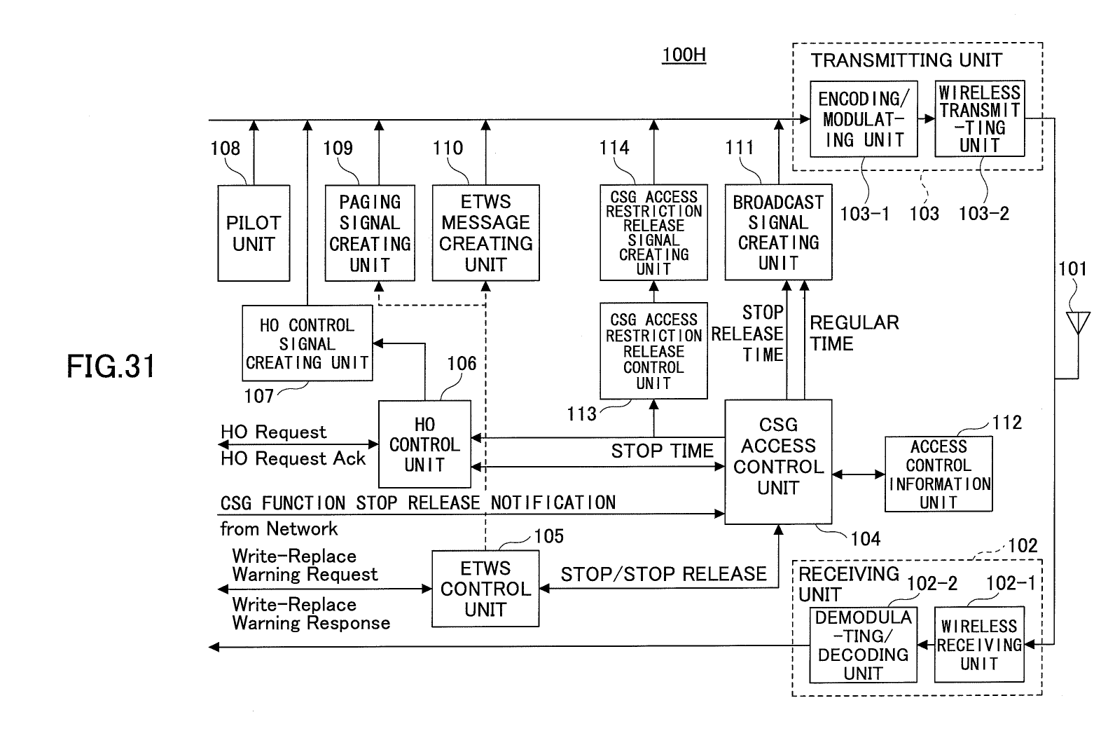

Next, a description is given of a block architecture example of the base station according to the fifth embodiment, with reference to FIG. 31. FIG. 31 illustrates a block architecture example of a base station according to the fifth embodiment.

In the block architecture of FIG. 31, the blocks having the same functions as the blocks of the base stations of the embodiments described above are denoted by the same reference numerals and specific descriptions are omitted.

A source base station 100H illustrated in FIG. 31 includes the antenna unit 101, the receiving unit 102, the transmitting unit 103, the CSG access control unit 104, the ETWS control unit 105, the HO control unit 106, the HO control signal creating unit 107, the pilot unit 108, the paging signal creating unit 109, the ETWS message creating unit 110, the broadcast signal creating unit 111, the CSG access restriction release control unit 113, and the CSG access restriction release signal creating unit 114.

In the source base station 100H illustrated in FIG. 31, the process of releasing CSG communication is the same as that of the first embodiment, and therefore specific descriptions are omitted.

In the source base station 100H illustrated in FIG. 31, when the ETWS control unit 105 detects completion of the transmission of a paging signal that is the first notification of ETWS and the transmission of an ETWS message that is the second notification, an ETWS-Replace Warning Response is returned to MME.

The MME 300 that has received the ETWS—Replace Warning Response sends a CSG function stop release notification for requesting to release regular communication, to the base station. Accordingly, the CSG access control unit 104 receives the above release notification. When the release notification is received, the CSG access control unit 104 resumes CSG communication.

When CSG communication is resumed in the fifth embodiment, the source base station 100H determines whether the broadcast contents correspond to a predetermined condition. For example, when the broadcast contents indicate information relevant to the earthquake intensity, the source base station 100H determines whether the broadcast contents indicate an earthquake intensity exceeding a predetermined level (for example, intensity 6 upper). Then, when the broadcast contents is determined to correspond to a predetermined condition, the source base station 100H continues to stop the communication by CSG procedures until a notification to resume communication by CSG procedures is received from a network. Then, when a notification to resume communication by CSG procedures is received, the source base station 100H notifies the resuming of communication by CSG procedures. When the broadcast contents are determined not to correspond to a predetermined condition, the source base station 100H notifies the resuming of communication by CSG procedures.

### Fifth Embodiment: Sequence Example

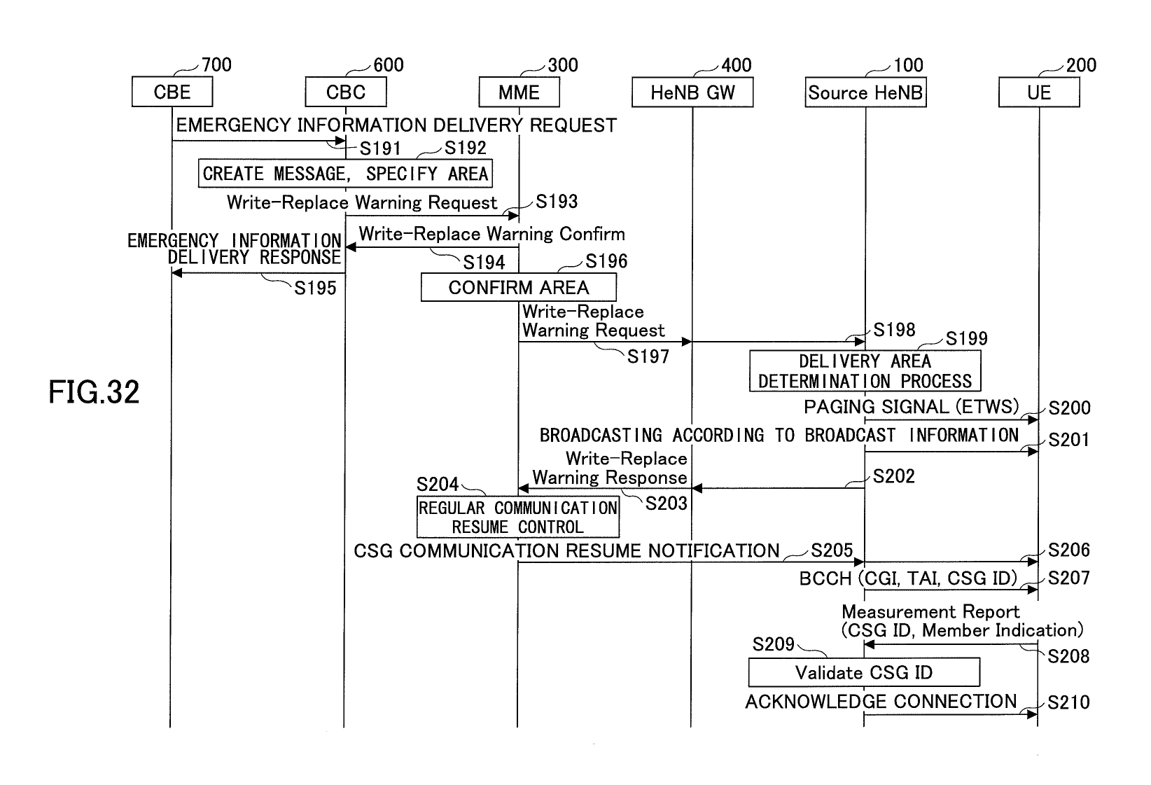

FIG. 32 illustrates a sequence example of a control procedure after transmitting an ETWS message according to the fifth embodiment.

Steps S191 through S203 in FIG. 32 are the same as steps S51 through S63 of FIG. 13, and therefore specific descriptions are omitted.

After step S203, the MME 300 performs regular communication resume control (step S204), and the MME 300 sends a CSG communication resume notification from the source base station 100 to the terminal via the HeNB GW 400 (steps S205, S206). Next, the source base station 100 sends, to the terminal 200, system information such as CGI as BCCH, TAI, and CSG ID (step S207).

The terminal 200 notifies the source base station 100 of the CGI, the TAI, and the CSG ID obtained from the source base station 100, and a measurement result (measurement report) including information of a member indication of CSG (step S208).

Next, the source base station 100 confirms whether the received CSG ID matches the CSG ID broadcast at step S207. When the CSG IDs match, the source base station 100 determines that the received CSG ID is valid and assigns an appropriate resource (step S209), and sends a connection acknowledgement to the terminal 200 (step S210).

That is to say, in the fifth embodiment, the CSG communication resume control is not performed by the base station but by the MME 300 that is a higher-level device of the base station.

In the above embodiments, the architecture may be constituted without HeNB. According to the above embodiments, an ETWS may be quickly received. Therefore, safe evacuation is possible.

Furthermore, by recording a program for realizing the communication process described in the above embodiments in a recording medium, a computer may be caused to execute the communication process described in the above embodiments.

This program may be recorded in a recording medium, and a computer or a mobile terminal may be caused to read the recording medium recording this program to realize the above control process. The recording medium may be various types of recording media such as a recording medium for optically, electrically, or magnetically recording information, for example, a CD-ROM, a flexible disk, and a magnet-optical disk, or a semiconductor memory for electrically recording information, for example, a ROM and a flash memory.

According to an aspect of the embodiments, an emergency is quickly and reliably received.

The present invention is not limited to the specific embodiments described herein, and variations and modifications may be made without departing from the scope of the present invention. Furthermore, all of or some of the elements in the above embodiments may be combined.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless communication system comprising:
one or more terminals; and
a base station capable of communicating with the one or more terminals, wherein
the base station includes
a specific communication control unit configured to control specific communication with a terminal belonging to a predetermined group among the one or more terminals,
a non-specific communication control unit configured to control non-specific communication that is not limited to the predetermined group, and
a warning message notifying unit configured to broadcast a warning message, wherein the warning message notifying unit starts broadcasting the warning message after transmitting a notification indicating that the broadcasting of the warning message will start in the non-specific communication, wherein
the terminal includes
a warning message receiving unit configured to attempt to receive the warning message broadcast from the base station, in a case where the notification indicating that the broadcasting of the warning message will start in the non-specific communication is detected.

2. The wireless communication system according to claim 1, wherein
the base station includes
a specific communication stop notifying unit configured to transmit a notification indicating to stop the specific communication, in a case where a request to transmit the warning message is received from a network, and
the warning message notifying unit configured to broadcast the warning message in the non-specific communication after the notification indicating to stop the specific communication is transmitted, wherein
the terminal includes
the warning message receiving unit configured to attempt to receive the warning message broadcast from the base station, in a case where the notification indicating to stop the specific communication is detected.

3. The wireless communication system according to claim 2, wherein
a terminal capable of performing the specific communication with the base station among the one or more terminals changes a communication method performed with the base station from the specific communication to the non-specific communication, after the notification indicating to stop the specific communication is detected.

4. The wireless communication system according to claim 2, wherein
the base station includes
a specific communication start notifying unit configured to transmit a notification indicating to start the specific communication after broadcasting the warning message, wherein
the terminal attempts to start the specific communication with the base station that has transmitted the notification indicating to start the specific communication, in a case where the notification indicating to start the specific communication is detected.

5. The wireless communication system according to claim 4, wherein
the base station starts to transmit the notification indicating to start the specific communication by the specific communication start notifying unit after receiving an instruction from a higher-level device.

6. A wireless communication system comprising:
one or more terminals; and
a base station capable of communicating with the one or more terminals, wherein
the base station includes
a specific communication control unit configured to control specific communication with a terminal belonging to a predetermined group among the one or more terminals,
a second identification information notifying unit configured to transmit second identification information used for the specific communication, the second identification information being different from first identification information used for the specific communication with the terminal belonging to the predetermined group, and
a warning message notifying unit configured to start broadcasting a warning message in the specific communication after the second identification information is transmitted, wherein
the terminal includes
a warning message receiving unit configured
to start the specific communication with the base station by using the second identification information that has been received and attempt to receive, in the specific communication, the warning message broadcast from the base station, in a case where reception of the second identification information is detected.

7. The wireless communication system according to claim 6, wherein
the base station includes
a communication method change notifying unit configured to transmit a change notification indicating to switch to a connection in the specific communication using the second identification information, to the terminal that is in wireless communication in the specific communication using the first identification information, in a case where the warning message is received, and
the warning message receiving unit of the terminal switches to a wireless connection in the specific communication using the second identification information and attempts to receive the warning message in the specific communication using the second identification information, in a case where the change notification is detected and the second identification information is detected.

8. The wireless communication system according to claim 7, wherein
the base station includes
a first warning broadcast unit configured to broadcast, before transmitting the change notification, first warning information that is simple information indicating contents of the warning message, to the terminal that is in wireless communication in the specific communication using the first identification information, in a case where the warning message is received, and
the terminal includes
a warning notifying unit configured to notify a user that the first warning information is received, in a case where broadcast of the first warning information is received, and
the warning message receiving unit of the terminal switches to a wireless connection in the specific communication using the second identification information and attempts to receive second warning information in the specific communication using the second identification information, in a case where the change notification is detected and the second identification information is detected.

9. A base station device capable of communicating with one or more terminals, the base station comprising:
a specific communication control unit configured to control specific communication with a terminal belonging to a predetermined group among the one or more terminals;
a non-specific communication control unit configured to control non-specific communication that is not limited to the predetermined group; and
a warning message notifying unit configured to broadcast a warning message, wherein the warning message notifying unit starts broadcasting the warning message after transmitting a notification indicating that the broadcasting of the warning message will start in the non-specific communication.

10. The base station device according to claim 9, further comprising:
a specific communication stop notifying unit configured to transmit a notification indicating to stop the specific communication, in a case where a request to transmit the warning message is received from a network, wherein
the warning message notifying unit is configured to broadcast the warning message in the non-specific communication after the notification indicating to stop the specific communication is transmitted.

11. A base station device capable of communicating with one or more terminals, the base station comprising:
a specific communication control unit configured to control specific communication with a terminal belonging to a predetermined group among the one or more terminals;
a second identification information notifying unit configured to transmit second identification information used for the specific communication, the second identification information being different from first identification information used for the specific communication with the terminal belonging to the predetermined group; and
a warning message notifying unit configured to start broadcasting a warning message in the specific communication after the second identification information is transmitted.

12. A terminal capable of communicating with a base station, the terminal comprising:
a warning message receiving unit configured to attempt to receive a warning message broadcast from the base station, in a case where a notification indicating that broadcasting of the warning message will start from the base station is detected, by non-specific communication that is not limited to a predetermined group controlled by the base station.

13. The terminal according to claim 12, wherein
the warning message receiving unit attempts to receive the warning message broadcast from the base station, in a case where a notification indicating to stop specific communication limited to the predetermined group from the base station is detected.

14. The terminal according to claim 13, wherein
the terminal changes a communication method performed with the base station from the specific communication to the non-specific communication, after the notification indicating to stop the specific communication is detected by the warning message receiving unit.

15. A method performed in a wireless communication system including one or more terminals and a base station capable of communicating with the one or more terminals, the method comprising:
controlling, by the base station, specific communication with a terminal belonging to a predetermined group among the one or more terminals;
controlling, by the base station, non-specific communication that is not limited to the predetermined group;
broadcasting a warning message by the base station, wherein the warning message is started to be broadcast after transmitting a notification indicating that the broadcasting of the warning message will start in the non-specific communication; and
attempting, by the terminal, to receive the warning message broadcast from the base station, in a case where the notification indicating that the broadcasting of the warning message will start in the non-specific communication is detected.

16. A method performed by a base station capable of communicating with the one or more terminals, the method comprising:
controlling specific communication with a terminal belonging to a predetermined group among the one or more terminals;
controlling non-specific communication that is not limited to the predetermined group; and
broadcasting a warning message, wherein the warning message is started to be broadcast after transmitting a notification indicating that the broadcasting of the warning message will start in the non-specific communication.

17. A method performed by a terminal device capable of communicating with a base station, the method comprising:
attempting to receive a warning message broadcast from the base station, in a case where a notification indicating that broadcasting of the warning message will start from the base station is detected, by non-specific communication that is not limited to a predetermined group controlled by the base station.
